(19) United States
(12) Patent Application Publication
(10) Pub. No.: US 2022/0010064 A1
(43) Pub. Date: Jan. 13, 2022

(54) FLUOROPOLYETHER GROUP-CONTAINING COMPOUND

(71) Applicant: DAIKIN INDUSTRIES, LTD., Osaka (JP)

(72) Inventors: Tsuneo YAMASHITA, Osaka (JP); Hisashi MITSUHASHI, Osaka (JP); Takeshi MAEHIRA, Osaka (JP); Yoshimi MOTONARI, Osaka (JP)

(73) Assignee: DAIKIN INDUSTRIES, LTD., Osaka (JP)

(21) Appl. No.: 17/487,246

(22) Filed: Sep. 28, 2021

Related U.S. Application Data
(63) Continuation of application No. PCT/JP2020/013740, filed on Mar. 26, 2020.

(30) Foreign Application Priority Data
Mar. 29, 2019 (JP) 2019-066329

(51) Int. Cl. C08G 65/336; C09D 171/00; C09D 5/00

(52) U.S. Cl. CPC C08G 65/336; C09D 5/00; C09D 171/00

(57) ABSTRACT

A fluoropolyether group-containing compound of the following formula (1):

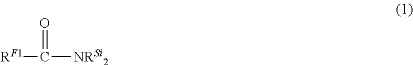

wherein R^{F1} and R^{Si} are as defined herein.

### CROSS REFERENCE TO RELATED APPLICATIONS

This application is a Rule 53 (b) Continuation of International Application No. PCT/JP2020/013740 filed Mar. 26, 2020, claiming priority based on Japanese Patent Application No. 2019-066329 filed Mar. 29, 2019, the respective disclosures of which are incorporated herein by reference in their entirety.

### TECHNICAL FIELD

The present disclosure relates to a fluoropolyether group-containing compound.

### BACKGROUND ART

Certain types of fluorine-containing silane compounds are known to be capable of providing excellent water-repellency, oil-repellency, antifouling property, and the like when used in surface treatment of a substrate. A layer obtained from a surface-treating agent containing a fluorine-containing silane compound (hereinafter, also referred to as a “surface-treating layer”) is applied as a so-called functional thin film to a large variety of substrates such as glass, plastics, fibers, and building materials.

A known such fluorine-containing compound is a fluoropolyether group-containing silane compound having a fluoropolyether group in the molecular backbone and a hydrolyzable group bonding to a Si atom at the molecular terminal or in the terminal part (Patent Literature 1).

### PRIOR ART LITERATURE

### Patent Literature

Patent Literature 1: JP 2000-327772 A

### SUMMARY OF INVENTION

The present disclosure provides [1] to [19] below.

[1] A fluoropolyether group-containing compound of the following formula (1) or (2):

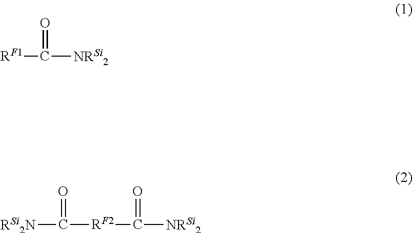

[In the formula:

R^{F1} is Rf¹—R^{F}—O_{q}—;

R^{F2} is —Rf²ₚ—R^{F}—O_{q}—;

Rf¹ is a C₁₋₁₆ alkyl group optionally substituted with one or more fluorine atoms;

Rf² is a C₁₋₆ alkylene group optionally substituted with one or more fluorine atoms;

R^{F} is each independently at each occurrence a group represented by the formula:

(OC₆F₁₂)ₐ—(OC₅F₁₀)_{b}—(OC₄F₈)_{c}—(OC₃R^{Fa}₆)_{d}—(OC₂F₄)ₑ—(OCF₂)_{f}—;

a, b, c, and d are each independently an integer of 0 or more and 30 or less, e and f are each independently an integer of 1 or more and 200 or less, the sum of a, b, c, d, e, and f is at least 5 or more, the occurrence order of the respective repeating units enclosed in parentheses provided with a subscript a, b, c, d, e, or f is not limited in the formula, and a ratio of e to f is 0.9 or more;
R^{Fa} is each independently at each occurrence a hydrogen atom, a fluorine atom, or a chlorine atom;
p is 0 or 1;
q is independently 0 or 1;
R^{Si} is each independently at each occurrence represented by the following formula (S1):

—X¹—SiR^{a1}ₚ₁R^{b1}_{q1}R^{c1}ᵣ₁ (S1);

X¹ is each independently at each occurrence a single bond, an oxygen atom, or a divalent organic group;

R^{a1} is each independently at each occurrence —Z^{1′}—SiR^{a1′}_{p1′}R^{b1′}_{q1′}R^{c1′}_{r1′};

Z^{1′} is each independently at each occurrence a single bond, an oxygen atom, or a divalent organic group;

R^{a1′} is each independently at each occurrence —Z^{1″}—SiR^{a1″}_{p1″}R^{b1″}_{q1″}R^{c1″}_{r1″};

Z^{1″} is each independently at each occurrence a single bond, an oxygen atom, or a divalent organic group;

R^{a1″} is each independently at each occurrence —Z^{1′″}—SiR^{a1′″}_{p1′″}R^{b1′″}_{q1′″}R^{c1′″}_{r1′″};

Z^{1′″} is each independently at each occurrence a single bond, an oxygen atom, or a divalent organic group;

R^{b1′″} is each independently at each occurrence a hydroxyl group or a hydrolyzable group;

R^{c1′″} is each independently at each occurrence a hydrogen atom or a monovalent organic group;

q1′″ is each independently at each occurrence an integer of 0 to 3;

r1′″ is each independently at each occurrence an integer of 0 to 3;

R^{b1″} is each independently at each occurrence a hydroxyl group or a hydrolyzable group;

R^{c1″} is each independently at each occurrence a hydrogen atom or a monovalent organic group;

p1″ is each independently at each occurrence an integer of 0 to 3;

q1″ is each independently at each occurrence an integer of 0 to 3;

r1″ is each independently at each occurrence an integer of 0 to 3;

R^{b1′} is each independently at each occurrence a hydroxyl group or a hydrolyzable group;

R^{c1′} is each independently at each occurrence a hydrogen atom or a monovalent organic group;

p1′ is each independently at each occurrence an integer of 0 to 3;

q1′ is each independently at each occurrence an integer of 0 to 3;

r1′ is each independently at each occurrence an integer of 0 to 3;

R^{b1} is each independently at each occurrence a hydroxyl group or a hydrolyzable group;

R^{c1} is each independently at each occurrence a hydrogen atom or a monovalent organic group;

p¹ is each independently at each occurrence an integer of 0 to 3;

q¹ is each independently at each occurrence an integer of 0 to 3;

r1 is each independently at each occurrence an integer of 0 to 3, and

at least one R^{b1}, R^{b1′}, R^{b1″}, or R^{b1} is present in each group represented by R^{Si}].

### Advantageous Effect

According to the present disclosure, it is possible to provide a fluoroalkyl group-containing compound suited for forming a cured layer having good friction durability.

### DESCRIPTION OF EMBODIMENTS

As used herein, the term “monovalent organic group” refers to a monovalent group containing carbon. The monovalent organic group is not limited, and may be a hydrocarbon group or a derivative thereof. The derivative of hydrocarbon group refers to a group that has one or more of N, O, S, Si, amide, sulfonyl, siloxane, carbonyl, carbonyloxy, and the like at the terminal or in the molecular chain of the hydrocarbon group.

As used herein, the “divalent organic group” is not limited, and examples thereof include a divalent group obtained by further removing one hydrogen atom from a hydrocarbon group.

As used herein, the term “hydrocarbon group” refers to a group that contains carbon and hydrogen and that is obtained by removing one hydrogen atom from a molecule. The hydrocarbon group is not limited, and examples thereof include a hydrocarbon group, such as an aliphatic hydrocarbon group and an aromatic hydrocarbon group, having 1 to 20 carbon atoms and optionally substituted with one or more substituents. The above “aliphatic hydrocarbon group” may be either straight, branched, or cyclic, and may be either saturated or unsaturated. The hydrocarbon group may contain one or more ring structures. The hydrocarbon group may have one or more of N, O, S, Si, amide, sulfonyl, siloxane, carbonyl, carbonyloxy, and the like at the terminal or in the molecular chain thereof.

As used herein, the substituent of the “hydrocarbon group” is not limited, and examples thereof include one or more groups selected from a halogen atom; and a C₁₋₆ alkyl group, a C₂₋₆ alkenyl group, a C₂₋₆ alkynyl group, a C₃₋₁₀ cycloalkyl group, a C₃₋₁₀ unsaturated cycloalkyl group, a 5 to 10-membered heterocyclyl group, a 5 to 10-membered unsaturated heterocyclyl group, a C₆₋₁₀ aryl group, and a 5 to 10-membered heteroaryl group, each of which is optionally substituted with one or more halogen atoms.

The alkyl group and the phenyl group may be herein unsubstituted or substituted, unless particularly noted. Each substituent of such groups is not limited, and examples thereof include one or more groups selected from a halogen atom, a C₁₋₆ alkyl group, a C₂₋₆ alkenyl group, and a C₂₋₆ alkynyl group.

As used herein, the term “hydrolyzable group” refers to a group that is able to undergo a hydrolysis reaction, that is, refers to a group that can be removed from the main backbone of a compound by a hydrolysis reaction. Examples of the hydrolyzable group include —OR^{h}, —OCOR^{h}, —O—N═CR^{h}₂, —NR^{h}₂, —NHR^{h}, and halogen (in these formulas, R^{h} represents a substituted or unsubstituted C₁₋₄ alkyl group).

The fluoropolyether group-containing compound of the present disclosure is a compound represented by the following formula (1) or (2).

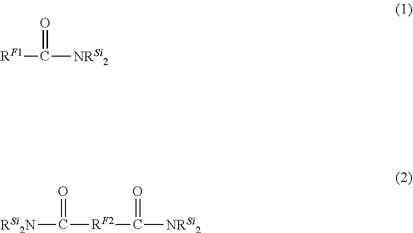

In formula (1), R^{F1} is each independently at each occurrence Rf¹—R^{F}—O_{q}—.

In the above formula (2), R^{F2} is —Rf²ₚ—R^{F}—O_{q}—.

In the above formula, Rf¹ is each independently at each occurrence a C₁₋₁₆ alkyl group optionally substituted with one or more fluorine atoms.

In the above C₁₋₁₆ alkyl group optionally substituted with one or more fluorine atoms, the “C₁₋₁₆ alkyl group” may be straight or branched, and it is preferably a straight or branched C₁₋₆ alkyl group, in particular C₁₋₃ alkyl group, and more preferably a straight C₁₋₆ alkyl group, in particular C₁₋₃ alkyl group.

The above Rf¹ is preferably a C₁₋₁₆ alkyl group substituted with one or more fluorine atoms, more preferably a CF₂H—C₁₋₁₅ perfluoroalkylene group, and even more preferably a C₁₋₁₆ perfluoroalkyl group.

The above C₁₋₁₆ perfluoroalkyl group may be straight or branched, and it is preferably a straight or branched C₁₋₆ perfluoroalkyl group, in particular C₁₋₃ perfluoroalkyl group, more preferably a straight C₁₋₆ perfluoroalkyl group, in particular C₁₋₃ perfluoroalkyl group, and specifically —CF₃, —CF₂CF₃, or —CF₂CF₂CF₃.

In the above formula, Rf² is a C₁₋₆ alkylene group optionally substituted with one or more fluorine atoms.

In the above C₁₋₆ alkylene group optionally substituted with one or more fluorine atoms, the “C₁₋₆ alkylene group” may be straight or branched, and it is preferably a straight or branched C₁₋₃ alkylene group, and more preferably a straight C₁₋₃ alkylene group.

The above Rf² is preferably a C₁₋₆ alkylene group substituted with one or more fluorine atoms, more preferably a C₁₋₆ perfluoroalkylene group, and even more preferably a C₁₋₃ perfluoroalkylene group.

The above C₁₋₆ perfluoroalkylene group may be straight or branched, and it is preferably a straight or branched C₁₋₃ perfluoroalkylene group, more preferably a straight C₁₋₃ perfluoroalkyl group, and specifically —CF₂—, —CF₂CF₂—, or —CF₂CF₂CF₂—.

In the above formula, p is 0 or 1. In one embodiment, p is 0. In another embodiment, p is 1.

In the above formulas, q is each independently at each occurrence 0 or 1. In one embodiment, q is 0. In another embodiment, q is 1.

In the above formulas (1) and (2), R^{F} is each independently at each occurrence a fluoropolyether group represented by the following formula. The structure described as R^{F} is bonded to the structure represented by Rf¹ on the left side in formula (1), and is bonded to the structure represented by Rf²ₚ on the left side in formula (2).

(OC₆F₁₂)ₐ—(OC₅F₁₀)_{b}—(OC₄F₈)_{c}—(OC₃R^{Fa}₆)_{d}—(OC₂F₄)ₑ—(OCF₂)_{f}—

[In the formula:

R^{Fa} is each independently at each occurrence a hydrogen atom, a fluorine atom, or a chlorine atom;

a, b, c, and d are each independently an integer of 0 or more and 30 or less;

e and f are each independently an integer of 1 or more and 200 or less;

the sum of a, b, c, d, e, and f is at least 5 or more;

the occurrence order of the respective repeating units enclosed in parentheses provided with a subscript a, b, c, d, e, or f is not limited in the formula; and the ratio of e to f (hereinafter, this may be referred to as an “e/f ratio”) is 0.9 or more.]

R^{Fa} is, each independently at each occurrence, preferably a hydrogen atom or a fluorine atom, and more preferably a fluorine atom.

These repeating units may be straight or branched, and are preferably straight. For example, —(OC₆F₁₂)— may be —(OCF₂CF₂CF₂CF₂CF₂CF₂)—, —(OCF(CF₃)CF₂CF₂CF₂CF₂)—, (OCF₂CF(CF₃)CF₂CF₂CF₂)—, —(OCF₂CF₂CF(CF₃)CF₂CF₂)—, (OCF₂CF₂CF₂CF(CF₃)CF₂)—, —(OCF₂CF₂CF₂CF₂CF(CF₃))—, or the like, and it is preferably —(OCF₂CF₂CF₂CF₂CF₂CF₂)—. —(OC₅F₁₀)— may be —(OCF₂CF₂CF₂CF₂CF₂)—, —(OCF(CF₃)CF₂CF₂CF₂)—, —(OCF₂CF(CF₃)CF₂CF₂)—, —(OCF₂CF₂CF(CF₃)CF₂)—, (OCF₂CF₂CF₂CF(CF₃))—, or the like, and it is preferably —(OCF₂CF₂CF₂CF₂CF₂)—. —(OC₄F₈)— may be any of —(OCF₂CF₂CF₂CF₂)—, —(OCF(CF₃)CF₂CF₂)—, —(OCF₂CF(CF₃)CF₂)—, —(OCF₂CF₂CF(CF₃))—, —(OC(CF₃)₂CF₂)—, —(OCF₂C(CF₃)₂)—, —(OCF(CF₃)CF(CF₃))—, (OCF(C₂F₅)CF₂)—, and —(OCF₂CF(C₂F₅))—, and it is preferably —(OCF₂CF₂CF₂CF₂)—. —(OC₃F₆)— (that is to say, in the above formula, R^{Fa} is a fluorine atom) may be any of —(OCF₂CF₂CF₂)—, —(OCF(CF₃)CF₂)—, and —(OCF₂CF(CF₃))—, and it is preferably —(OCF₂CF₂CF₂)—. Also, —(OC₂F₄)— may be any of —(OCF₂CF₂)— and —(OCF(CF₃))—, and it is preferably —(OCF₂CF₂)—.

The above a and b may be 0.

In one embodiment, the above a, b, c, and d are, each independently, preferably an integer of 20 or less, more preferably an integer of 10 or less, and particularly preferably an integer of 5 or less, and it may be 0.

In one embodiment, the sum of a, b, c, and d is preferably 30 or less, more preferably 20 or less, even more preferably 10 or less, and particularly preferably 5 or less.

In one embodiment, the ratio of the sum of e and f to the sum of a, b, c, d, e, and f in R^{F} is preferably 0.80 or more, more preferably 0.90 or more, even more preferably 0.98 or more, and particularly preferably 0.99 or more.

In a preferred embodiment, R^{F} is —(OC₄F₈)_{c}—(OC₃F₆)_{d}—(OC₂F₄)ₑ—(OCF₂)_{f}— (in the formula, c and d are each independently an integer of 0 or more and 30 or less; e and f are each independently an integer of 1 or more and 200 or less, preferably 5 or more and 200 or less, and more preferably 10 or more and 200 or less; and the occurrence order of the respective repeating units enclosed in parentheses provided with a subscript c, d, e, or f is not limited in the formula). Preferably, R^{F} is —(OCF₂CF₂CF₂CF₂)_{c}—(OCF₂CF₂CF₂)_{d}—(OCF₂CF₂)ₑ—(OCF₂)_{f}—. In one embodiment, R^{F} may be —(OC₂F₄)ₑ—(OCF₂)_{f}— (in the formula, e and f are each independently an integer of 1 or more and 200 or less, preferably 5 or more and 200 or less, and more preferably 10 or more and 200 or less, and the occurrence order of the respective repeating units enclosed in parentheses provided with a subscript e or f is not limited in the formula).

More preferably, R^{F} is —(OC₂F₄)ₑ—(OCF₂)_{f}— (in the formula, e and f are each independently an integer of 1 or more and 200 or less, preferably 5 or more and 200 or less, and more preferably 10 or more and 200 or less, and the occurrence order of the respective repeating units enclosed in parentheses provided with a subscript e or f is not limited in the formula).

In one embodiment, e may be an integer of 9 or more and 90 or less and f may be an integer of 10 or more and 100 or less, or e may be an integer of 9 or more and 45 or less and f may be an integer of 10 or more and 50 or less.

In one embodiment, the sum of e and f is preferably 20 or more, more preferably 30 or more, and particularly preferably 40 or more.

In one embodiment, the sum of e and f is preferably 200 or less, more preferably 180 or less, even more preferably 160 or less, and particularly preferably 150 or less.

In the above R^{F}, the e/f ratio is 0.9 or more and preferably 1.0 or more, such as 1.1 or more, and it may be 1.3 or more. The e/f ratio is preferably 10.0 or less, 9.0 or less, more preferably 5.0 or less, even more preferably 2.0 or less, and particularly preferably 1.5 or less. The e/f ratio may be, for example, 0.9 to 10.0, specifically 0.9 to 5.0, more specifically 0.9 to 2.0, and even more specifically 0.9 to 1.5.

When the e/f ratio becomes too low, the perfluoroalkyl group-containing compound (or a composition containing such a compound, for example, a surface-treating agent) may behave like a dilatant fluid before curing, that is, behave similarly to a solid in response to shear stress, and as a result, the lubricity of the cured layer to be formed may be reduced. In addition, the hydrolyzability of the cured layer to be formed using the fluoropolyether group-containing compound may be increased, and the durability of the cured layer may be decreased. When the e/f ratio becomes too high, the dynamic friction coefficient of the cured layer to be formed using the fluoropolyether group-containing compound becomes high, and a cured layer with sufficient friction durability may not be obtained. Furthermore, when the e/f ratio is in the above range, the proportion of oxygen atoms in the PFPE chain becomes smaller than when the e/f ratio is less than 0.9, that is, the proportion of fluorine atoms becomes larger. As a result, it is thought that the water- and oil-repellency of the cured layer to be formed becomes higher.

In the present disclosure, the use of a compound having R^{F} as described above provides good chemical durability (chemical resistance), friction durability, water-repellency, oil-repellency, antifouling property (for example, preventing fouling such as fingerprints from adhering), waterproof property (preventing water from penetrating into electronic components and the like), surface lubricity (or lubricity, such as removability by wiping for fouling including fingerprints and the like and excellent tactile sensations to the fingers), or the like of the cured layer to be formed using the compound (for example, surface-treating layer). This is thought to be because the use of a compound having R^{F} as described above reduces the dynamic friction coefficient of the surface of the cured layer to be formed from the compound.

The cured layer (or cured film) to be formed using the compound of the present disclosure may be less likely to be decomposed at a high temperature. The term “less likely to be decomposed at a high temperature” means that, for example, the 1% decomposition temperature of the cured layer is at a relatively high temperature. That is, the compound of the present disclosure can contribute to formation of a cured layer that can be used in a wide temperature range. As used herein, the term “1% decomposition temperature” refers to a temperature at which 1 mass % of the cured layer is decomposed based on the entire cured layer. The 1% decomposition temperature refers to a value measured by thermogravimetric/differential thermal analysis (TG/DTA), and specifically, it is measured in the range of 25° C. to 600° C. under an air atmosphere with a temperature-increasing rate of 10° C./min. For example, DTG-60 from Shimadzu Corporation can be used for the above TG/DTA.

The number average molecular weight of the R^{F1} and R^{F2} moieties is not limited, and it is, for example, 500 to 30,000, preferably 1,500 to 30,000, and more preferably 2,000 to 10,000. Herein, the number average molecular weight of R^{F1} and R^{F2} is defined as a value obtained by ¹⁹F-NMR measurement.

In another embodiment, the number average molecular weight of the R^{F1} and R^{F2} moieties is 500 to 30,000, preferably 1,000 to 20,000, more preferably 2,000 to 15,000, and even more preferably 2,000 to 10,000, and it may be, for example, 3,000 to 8,000. In another embodiment, the number average molecular weight of the R^{F1} and R^{F2} moieties may be 2,000 to 8.000.

In another embodiment, the number average molecular weight of the R^{F1} and R^{F2} moieties is 3,000 to 30,000, preferably 3,500 to 15,000, and more preferably 3,500 to 8,000, and it may be, for example, 4,000 to 8,000 or 5,000 to 8,000.

In another embodiment, the number average molecular weight of the R^{F1} and R^{F2} moieties may be 5,000 to 30,000, preferably 8,000 to 15,000, and more preferably 10,000 to 15,000.

In one embodiment, the fluoropolyether group-containing compound of the present disclosure may have an average molecular weight of the R^{F1} and R^{F2} moieties in the range of 2,000 to 8,000 and an e/f ratio in the range of 0.9 to 2.0, or may have an average molecular weight of the R^{F1} and R^{F2} moieties in the range of 3,500 to 8,000 and an e/f ratio in the range of 0.9 to 1.5. In another embodiment, the number average molecular weight of the R^{F1} and R^{F2} moieties is in the range of 10,000 to 15,000 and the e/f ratio is in the range of 0.9 to 2.0. The fluoropolyether group-containing compound can contribute to formation of a cured layer that has an extremely low dynamic friction coefficient and exhibits good lubrication characteristics.

In the present disclosure, in the fluoropolyether group-containing compounds represented by formulas (1) and (2), the group represented by R^{F1} or R^{F2} and the group represented by R^{Si} are bonded by C(═O)—N. Here, in the compounds represented by formulas (1) and (2), the group represented by R^{F1} or R^{F2} is a group containing a fluoropolyether group that mainly provides water-repellency, surface lubricity, and the like, and the group represented by R^{Si} is a silane moiety that provides bonding ability to a substrate. As described above, the inclusion of the structure represented by C(═O)—N can provide good chemical resistance (for example, resistance to strong alkaline aqueous solutions and strong acid aqueous solutions, and resistance to oxidation by active oxygen species) of the cured layer to be formed using the fluoropolyether group-containing compounds represented by formulas (1) and (2).

Furthermore, the fluoropolyether group-containing compounds represented by formulas (1) and (2) of the present disclosure have an e/f ratio in a particular range in the group represented by R^{F} included in R^{F1} or R^{F2}. By having such a structure, the cured layer to be formed using the fluoropolyether group-containing compounds represented by formulas (1) and/or (2) can exhibit extremely high chemical resistance, friction durability, water-repellency, oil-repellency, antifouling property (for example, preventing fouling such as fingerprints from adhering), waterproof property (preventing water from penetrating into electronic components and the like), or surface lubricity (or lubricity, such as removability by wiping for fouling including fingerprints and the like and excellent tactile sensations to the fingers).

In the above formulas (1) and (2), R^{Si} is each independently at each occurrence a monovalent group containing a Si atom to which a hydroxyl group, hydrolyzable group, hydrogen atom, or monovalent organic group is bonded.

In the fluoropolyether group-containing compounds represented by formulas (1) and (2), two groups represented by R^{Si} are bonded to the N atom of C(═O)—N. By having such a structure, the cured layer to be formed using the compound of the present disclosure can have good bonding strength to the substrate, resulting in good chemical resistance (for example, durability against solvents, durability against artificial sweat, resistance to strong alkaline aqueous solutions and strong acid aqueous solutions, and resistance to oxidation by active oxygen species), friction durability, weather resistance, durability under UV exposure, and the like.

R^{Si} is each independently at each occurrence represented by the following formula (S1).

—X¹—SiR^{a1}ₚ₁R^{b1}_{q1}R^{c1}ᵣ₁ (S1)

In formula (S1), X¹ is each independently at each occurrence a single bond, an oxygen atom, or a divalent organic group.

In one embodiment, X¹ is a single bond.

In one embodiment, X¹ is an oxygen atom.

X¹ is preferably a divalent organic group.

Examples of the divalent organic group X¹ include, but are not limited to, a group represented by the following formula:

(Z²¹)_{z11}—(X²)_{z12}—(Z²²)_{z13}—

In the formula, Z²¹ and Z²² are divalent organic groups.

X² is an oxygen atom.

z11 is 0 or 1; z12 is 0 or 1; and z13 is 0 or 1. At least one of z11 and z13 is 1.

X¹ is preferably a C₁₋₆ alkylene group, —(CH₂)_{z5}—O—(CH₂)_{z6}— (in the formula, z5 is an integer of 0 to 6 such as an integer of 1 to 6, z6 is an integer of 0 to 6 such as an integer of 1 to 6, and the sum of z5 and z6 is 1 or more), or —(CH₂)_{z7}-phenylene-(CH₂)_{z8}— (in the formula, z7 is an integer of 0 to 6 such as an integer of 1 to 6, z8 is an integer of 0 to 6 such as an integer of 1 to 6, and preferably the sum of z7 and z8 is 1 or more). The C₁₋₆ alkylene group may be straight or may be branched, but it is preferably straight. These groups may be substituted with one or more substituents selected from, for example, a fluorine atom, a C₁₋₆ alkyl group, a C₂₋₆ alkenyl group, and a C₂₋₆ alkynyl group, but it is preferably unsubstituted.

In a preferred embodiment, X¹ is a C₁₋₆ alkylene group or —(CH₂)_{z7}-phenylene-(CH₂)_{z8}—, and preferably -phenylene-(CH₂)_{z8}—. When X¹ is the group, the light resistance, in particular ultraviolet resistance, of the cured layer to be formed can be further enhanced. Preferably, z7 is an integer of 0 to 6 and z8 is an integer of 1 to 6.

In another preferred embodiment, the above X¹ is a C₁₋₆ alkylene group, and more preferably a C₁₋₃ alkylene group. When X¹ has the structure, the light resistance, in particular ultraviolet resistance, of the cured layer to be formed can be further enhanced.

In one embodiment, X¹ can be —CH₂CH₂CH₂—.

R^{a1} is each independently at each occurrence —Z^{1′}—SiR^{a1′}_{p1′}R^{b1′}_{q1′}R^{c1′}_{r1′}.

The above Z^{1′} is each independently at each occurrence a single bond, an oxygen atom, or a divalent organic group.

In one embodiment, Z^{1′} is a single bond.

In one embodiment, Z^{1′} is an oxygen atom.

Z^{1′} is preferably a divalent organic group.

In a preferred embodiment, those forming a siloxane bond with the Si atom to which Z^{1′} is bonded are not included in Z^{1′}. That is, in formula (S1), (Si—Z^{1′}—Si) does not include a siloxane bond.

Examples of the divalent organic group Z^{1′} include, but are not limited to, a group represented by the following formula:

—(Z^{21′})_{z11′}—(X^{2′})z_{12′}—(Z^{22′})_{z13′}—

In the formula, Z^{21′} and Z^{22′} are divalent organic groups.

X^{2′} is an oxygen atom.

z11′ is 0 or 1; z12′ is 0 or 1; and z13′ is 0 or 1. At least one of z11′ and z13′ is 1.

Z^{1′} is preferably a C₁₋₆ alkylene group, —(CH₂)_{z5′}—O—(CH₂)_{z6′}— (in the formula, z5′ is an integer of 0 to 6 such as an integer of 1 to 6, z6′ is an integer of 0 to 6 such as an integer of 1 to 6, and the sum of z5′ and z6′ is 1 or more), or —(CH₂)_{z7′}-phenylene-(CH₂)_{z8′}— (in the formula, z7′ is an integer of 0 to 6 such as an integer of 1 to 6, z8′ is an integer of 0 to 6 such as an integer of 1 to 6, and preferably the sum of z7′ and z8′ is 1 or more). The C₁₋₆ alkylene group may be straight or branched, but preferably straight. These groups may be substituted with one or more substituents selected from, for example, a fluorine atom, a C₁₋₆ alkyl group, a C₂₋₆ alkenyl group, and a C₂₋₆ alkynyl group, but preferably unsubstituted.

In a preferred embodiment, Z^{1′} is a C₁₋₆ alkylene group or —(CH₂)_{z7′}-phenylene-(CH₂)_{z8′}—, and preferably -phenylene-(CH₂)_{z8′}—. When Z^{1′} is the group, the light resistance, in particular ultraviolet resistance, of the cured layer to be formed can be further enhanced. Preferably, z7′ is an integer of 0 to 6 and z8′ is an integer of 1 to 6.

In another preferred embodiment, the above Z^{1′} is a C₁₋₆ alkylene group, and more preferably a C₁₋₃ alkylene group.

When Z^{1′} has the structure, the light resistance, in particular ultraviolet resistance, of the cured layer to be formed can be further enhanced.

In one embodiment, Z^{1′} can be —CH₂CH₂CH₂—. In another embodiment, Z^{1′} can be —CH₂CH₂—.

The above R^{a1′} is each independently at each occurrence

—Z^{1″}—SiR^{a1″}_{p1″}R^{b1″}_{q1″}R^{c1″}_{r1″}.

The above Z^{1″} is each independently at each occurrence a single bond, an oxygen atom, or a divalent organic group.

In one embodiment, Z^{1″} is a single bond.

In one embodiment, Z^{1″} is an oxygen atom.

Z^{1″} is preferably a divalent organic group.

In a preferred embodiment, those forming a siloxane bond with the Si atom to which Z^{1″} is bonded are not included in Z^{1″}. That is, in formula (S1), (Si—Z^{1″}—Si) does not include a siloxane bond.

Examples of the divalent organic group Z^{1″} include, but are not limited to, a group represented by the following formula:

(Z^{21″})_{z11″}—(X^{2″})_{z12″}—(Z^{22″})_{z13″}—

In the formula, Z^{21″} and Z^{22″} are divalent organic groups.

X²″ is an oxygen atom.

z11″ is 0 or 1; z12″ is 0 or 1; and z13″ is 0 or 1. At least one of z11″ and z13″ is 1.

Z^{1″} is preferably a C₁₋₆ alkylene group, —(CH₂)_{z5″}—O—(CH₂)_{z6″}— (in the formula, z5″ is an integer of 0 to 6 such as an integer of 1 to 6, z6″ is an integer of 0 to 6 such as an integer of 1 to 6, and the sum of z5″ and z6″ is 1 or more), or —(CH₂)_{z7″}-phenylene-(CH₂)_{z8″}— (in the formula, z7″ is an integer of 0 to 6 such as an integer of 1 to 6, z8″ is an integer of 0 to 6 such as an integer of 1 to 6, and preferably the sum of z7″ and z8″ is 1 or more). The C₁₋₆ alkylene group may be straight or branched, but it is preferably straight. These groups may be substituted with, for example, one or more substituents selected from a fluorine atom, a C₁₋₆ alkyl group, a C₂₋₆ alkenyl group, and a C₂₋₆ alkynyl group, but it is preferably unsubstituted.

In a preferred embodiment, Z^{1″} is a C₁₋₆ alkylene group or —(CH₂)_{z7″}-phenylene-(CH₂)_{z8″}—, and preferably -phenylene-(CH₂)_{z8″}—. When Z^{1″} is the group, the light resistance, in particular ultraviolet resistance, of the cured layer to be formed can be further enhanced. Preferably, z7″ is an integer of 0 to 6 and z8″ is an integer of 1 to 6.

In another preferred embodiment, the above Z^{1″} is a C₁₋₆ alkylene group, and more preferably a C₁₋₃ alkylene group. When Z^{1″} has the structure, the light resistance, in particular ultraviolet resistance, of the cured layer to be formed can be further enhanced.

In one embodiment, Z^{1″} may be —CH₂CH₂CH₂—. In another embodiment, Z^{1′} may be —CH₂CH₂—.

The above R^{a1″} is each independently at each occurrence

—Z^{1′″}—SiR^{b1′″}_{q1′″}R^{c1′″}_{r1′″}.

The above Z^{1′″} is each independently at each occurrence a single bond, an oxygen atom, or a divalent organic group.

In one embodiment, Z^{1′″} is a single bond.

In one embodiment, Z^{1′″} is an oxygen atom.

Z^{1′″} is preferably a divalent organic group.

In a preferred embodiment, those forming a siloxane bond with the Si atom to which Z^{1′″} is bonded are not included in Z^{1′″}. That is, in formula (S1), (Si—Z^{1′″}—Si) does not include a siloxane bond.

Examples of the divalent organic group Z^{1′″} include, but are not limited to, a group represented by the following formula:

(Z^{21′″})_{z11′″}—(X^{2′″})_{z12′″}—(Z^{22′″})_{z13′″}—

In the formula, Z^{21′″} and Z^{22′″} are divalent organic groups.

X^{2″′} is an oxygen atom.

z11′″ is 0 or 1; z12″′ is 0 or 1; and z13″′ is 0 or 1. At least one of z11′″ and z13″′ is 1.

Z^{1′″} is preferably a C₁₋₆ alkylene group, —(CH₂)_{z5″′}—O—(CH₂)_{z6″′}— (in the formula, z5″′ is an integer of 0 to 6 such as an integer of 1 to 6, z6″′ is an integer of 0 to 6 such as an integer of 1 to 6, and the sum of z5″′ and z6″′ is 1 or more), or —(CH₂)_{z7″′}-phenylene-(CH₂)_{z8″′}— (in the formula, z7″′ is an integer of 0 to 6 such as an integer of 1 to 6, z8″′ is an integer of 0 to 6 such as an integer of 1 to 6, and preferably the sum of z1 and z8″′ is 1 or more). The C₁₋₆ alkylene group may be straight or branched, but preferably straight. These groups may be substituted with, for example, one or more substituents selected from a fluorine atom, a C₁₋₆ alkyl group, a C₂₋₆ alkenyl group, and a C₂₋₆ alkynyl group, but preferably unsubstituted.

In a preferred embodiment, Z^{1′″} is a C₁₋₆ alkylene group or —(CH₂)_{z7″′}-phenylene-(CH₂)_{z8″′}, and preferably -phenylene-(CH₂)_{z8″′}—. When Z^{1″} is the group, the light resistance, in particular, ultraviolet resistance of the cured layer to be formed can be further enhanced. Preferably, z7″′ is an integer of 0 to 6 and z8″′ is an integer of 1 to 6.

In another preferred embodiment, the above Z^{1′″} is a C₁₋₆ alkylene group, and more preferably a C₁₋₃ alkylene group. When Z^{1′″} has the structure, the light resistance, in particular ultraviolet resistance, of the cured layer to be formed can be further enhanced.

In one embodiment, Z^{1′″} can be —CH₂CH₂CH₂—. In another embodiment, Z^{1′″} can be —CH₂CH₂—.

The above R^{b1″′} is each independently at each occurrence a hydroxyl group or a hydrolyzable group. Preferably, R^{b1″′} is each independently at each occurrence a hydrolyzable group.

R^{b1″′} is, each independently at each occurrence, preferably —OR^{h}, —OCOR^{h}, —O—N═CR^{h}₂, —NR^{h}₂, —NHR^{h}, or halogen (in these formulas, R^{h} represents a substituted or unsubstituted C₁₋₄ alkyl group), and more preferably —OR^{h} (that is, an alkoxy group). Examples of R^{h} include unsubstituted alkyl groups such as a methyl group, an ethyl group, a propyl group, an isopropyl group, a n-butyl group, and an isobutyl group; and substituted alkyl groups such as a chloromethyl group. Among such groups, an alkyl group, in particular an unsubstituted alkyl group, is preferable, and a methyl group or an ethyl group is more preferable. In one embodiment, R^{h} is a methyl group, and in another embodiment, R^{h} is an ethyl group.

The above R^{c1″′} is each independently at each occurrence a hydrogen atom or a monovalent organic group. The monovalent organic group is a monovalent organic group excluding the above hydrolyzable group.

In R^{c1″′}, the monovalent organic group is preferably a C₁₋₂₀ alkyl group, more preferably a C₁₋₆ alkyl group, and even more preferably a methyl group.

The above q1″′ is each independently at each occurrence an integer of 0 to 3, and the above r1″′ is each independently at each occurrence an integer of 0 to 3. The sum of q1″′ and r1″′ is 3 in the (SiR^{b1″′}_{q1″′}R^{c1″′}_{r1″′}) unit.

Preferably, q1″′ is an integer of 1 to 3 and r1″′ is an integer of 0 to 2, more preferably, q1″′ is 2 or 3 and r1″′ is 0 or 1, and particularly preferably, q1″′ is 3.

The above R^{b1″} is each independently at each occurrence a hydroxyl group or a hydrolyzable group. Preferably, R^{b1″} is each independently at each occurrence a hydrolyzable group.

R^{b1″} is, each independently at each occurrence, preferably —OR^{h}, —OCOR^{h}, —O—N═CR^{h}₂, —NR^{h}₂, —NHR^{h}, or halogen (in these formulas, R^{h} represents a substituted or unsubstituted C₁₋₄ alkyl group), and more preferably —OR^{h} (that is, an alkoxy group). Examples of R^{h} include unsubstituted alkyl groups such as a methyl group, an ethyl group, a propyl group, an isopropyl group, a n-butyl group, and an isobutyl group, and substituted alkyl groups such as a chloromethyl group. Among such groups, an alkyl group, in particular an unsubstituted alkyl group, is preferable, and a methyl group or an ethyl group is more preferable. R^{h} is a methyl group in one embodiment, and R^{h} is an ethyl group in another embodiment.

The above R^{c1″} is each independently at each occurrence a hydrogen atom or a monovalent organic group. The monovalent organic group is a monovalent organic group excluding the above hydrolyzable group.

In R^{c1″}, the monovalent organic group is preferably a C₁₋₂₀ alkyl group, more preferably a C₁₋₆ alkyl group, and even more preferably a methyl group.

The above p1″ is each independently at each occurrence an integer of 0 to 3, the above q1″ is each independently at each occurrence an integer of 0 to 3, and the above r1″ is each independently at each occurrence an integer of 0 to 3. The sum of p1″, q1″, and r1″ is 3 in the (SiR^{a1″}_{p1″}R^{b1″}_{q1″}R^{c1″}_{r1″}) unit.

In one embodiment, p1″ is 0.

In one embodiment, p1″ may be each independently an integer of 1 to 3, an integer of 2 to 3, or 3 in each (SiR^{a1″}_{p1″}R^{b1″}_{q1″}R^{c1″}_{r1″}) unit. In a preferred embodiment, p1″ is 3.

In one embodiment, q1″ is each independently an integer of 1 to 3, preferably an integer of 2 to 3, and more preferably 3 in each (SiR^{a1″}_{p1″}R^{b1″}_{q1″}R^{c1″}_{r1″}) unit.

In one embodiment, p1″ is 0, and q1″ is each independently an integer of 1 to 3, preferably an integer of 2 to 3, and even more preferably 3 in each (SiR^{a1″}_{p1″}R^{b1″}_{q1″}R^{c1″}_{r1″}) unit.

The above R^{b1′} is each independently at each occurrence a hydroxyl group or a hydrolyzable group. Preferably, R^{b1′} is each independently at each occurrence a hydrolyzable group.

R^{b1′} is, each independently at each occurrence, preferably —OR^{h}, —OCOR^{h}, —O—N═CR^{h}₂, —NR^{h}₂, —NHR^{h}, or halogen (in these formulas, R^{h} represents a substituted or unsubstituted C₁₋₄ alkyl group), and more preferably —OR^{h} (that is, an alkoxy group). Examples of R^{h} include unsubstituted alkyl groups such as a methyl group, an ethyl group, a propyl group, an isopropyl group, a n-butyl group and an isobutyl group; and substituted alkyl groups such as a chloromethyl group. Among such groups, an alkyl group, in particular an unsubstituted alkyl group, is preferable, and a methyl group or an ethyl group is more preferable. In one embodiment, R^{h} is a methyl group and in another embodiment, R^{h} is an ethyl group.

The above R^{c1′} is each independently at each occurrence a hydrogen atom or a monovalent organic group. The monovalent organic group is a monovalent organic group excluding the above hydrolyzable group.

In R^{c1′}, the monovalent organic group is preferably a C₁₋₂₀ alkyl group, more preferably a C₁₋₆ alkyl group, and even more preferably a methyl group.

The above p1′ is each independently at each occurrence an integer of 0 to 3, the above q1′ is each independently at each occurrence an integer of 0 to 3, and the above r1′ is each independently at each occurrence an integer of 0 to 3. The sum of p1′, q1′, and r1′ is 3 in the (SiR^{a1′}_{p1′}R^{b1′}_{q1′}R^{c1′}_{r1′}) unit.

In one embodiment, p1′ is 0.

In one embodiment, p1′ may be each independently an integer of 1 to 3, an integer of 2 to 3, or 3 in each (SiR^{a1′}_{p1′}R^{b1′}_{q1′}R^{c1′}_{r1′}) unit. In a preferred embodiment, p1′ is 3.

In one embodiment, q1′ is each independently an integer of 1 to 3, preferably an integer of 2 to 3, and more preferably 3 in each (SiR^{a1′}_{p1′}R^{b1′}_{q1′}R^{c1′}_{r1′}) unit.

In one embodiment, p1′ is 0, and q1′ is each independently an integer of 1 to 3, preferably an integer of 2 to 3, and even more preferably 3 in each (SiR^{a1′}_{p1′}R^{b1′}_{q1′}R^{c1′}_{r1′}) unit.

The above R^{b1} is each independently at each occurrence a hydroxyl group or a hydrolyzable group. Preferably, R^{b1} is each independently at each occurrence a hydrolyzable group.

The above R^{c1} is each independently at each occurrence a hydrogen atom or a monovalent organic group. The monovalent organic group is a monovalent organic group excluding the above hydrolyzable group.

In R^{c1}, the monovalent organic group is preferably a C₁₋₂₀ alkyl group, more preferably a C₁₋₆ alkyl group, and even more preferably a methyl group.

The above p1 is each independently at each occurrence an integer of 0 to 3, the above q1 is each independently at each occurrence an integer of 0 to 3, and the above r1 is each independently at each occurrence an integer of 0 to 3. The sum of p1, q1, and r1 is 3 in the (SiR^{a1}ₚ₁R^{b1}_{q1}R^{c1}ᵣ₁) unit.

In one embodiment, p1 is 0.

In one embodiment, p1 may be each independently an integer of 1 to 3, an integer of 2 to 3, or 3 in each (SiR^{a1}ₚ₁R^{b1}_{q1}R^{c1}ᵣ₁) unit. In a preferred embodiment, p1 is 3.

In one embodiment, q1 is each independently an integer of 1 to 3, preferably an integer of 2 to 3, and more preferably 3 in each (SiR^{a1}ₚ₁R^{b1}_{q1}R^{c1}ᵣ₁) unit.

In one embodiment, p1 is 0, and q1 is each independently an integer of 1 to 3, preferably an integer of 2 to 3, and even more preferably 3 in each (SiR^{a1}ₚ₁R^{b1}_{q1}R^{c1}ᵣ₁) unit.

At least one R^{b1}, R^{b1′}, R^{b1″}, or R^{b1′″} is present in each group represented by the above R^{Si}. That is, in formula (1) or (2), the group represented by R^{Si} bonded to the N atom has a Si atom bonded to at least one hydroxyl group or hydrolyzable group.

In other word, the group represented by R^{Si} has at least one of the following:
a group represented by —X¹—SiR^{a1}ₚ₁R^{b1}_{q1}R^{c1}ᵣ₁ (in the formula, q1 is an integer of 1 to 3, q1 is preferably 2 or 3, and q1 is more preferably 3. Provided that the sum of p1, q1, and r1 is 3);
a group represented by —Z^{1′}—SiR^{a1′}_{p1′}R^{b1′}_{q1′}R^{c1′}_{r1′} (in the formula, q1′ is an integer of 1 to 3, q1′ is preferably 2 or 3, and q1′ is more preferably 3. Provided that the sum of p1′, q1′, and r1′ is 3);
a group represented by —Z^{1″}—SiR^{a1″}_{p1″}R^{b1″}_{q1″}R^{c1″}_{r1″} (in the formula, q1″ is an integer of 1 to 3, q1″ is preferably 2 or 3, and q1″ is more preferably 3. Provided that the sum of p1″, q1″, and r1″ is 3); and
a group represented by —Z^{1′″}—SiR^{a1′″}_{p1′″}R^{b1′″}_{q1′″}R^{c1′″}_{r1′″} (in the formula, q1′″ is an integer of 1 to 3, q1′″ is preferably 2 or 3, and q1 is more preferably 3. Provided that the sum of q1″′ and r1′″ is 3).

It is preferable that the Si atom bonded to a hydroxyl group or hydrolyzable group be present in the terminal portion of the group represented by R^{Si}. In other words, preferably, the Si atom to which a hydroxyl group or hydrolyzable group is bonded is present in the terminal portion of formula (1) and formula (2).

The group represented by the above R^{Si} preferably has at least one of the following:
a group represented by —X¹—SiR^{a1}ₚ₁R^{b1}_{q1}R^{c1}ᵣ₁ (in the formula, q1 is an integer of 1 to 3, q1 is preferably 2 or 3, and q1 is more preferably 3. Provided that the sum of p1, q1, and r1 is 3);
a group represented by —Z^{1′}—SiR^{a1′}_{p1′}R^{b1′}_{q1′}R^{c1′}_{r1′} (in the formula, q1′ is an integer of 1 to 3, q1′ is preferably 2 or 3, and q1′ is more preferably 3. Provided that the sum of p1′, q1′, and r1′ is 3);
a group represented by —Z^{1″}—SiR^{a1″}_{p1″}R^{b1″}_{q1″}R^{c1″}_{r1″} (in the formula, q1″ is an integer of 1 to 3, q1″ is preferably 2 or 3, and q1″ is more preferably 3. Provided that the sum of p1″, q1″, and r1″ is 3); and
a group represented by —Z^{1′″}—SiR^{a1′″}_{p1′″}R^{b1′″}_{q1′″}R^{c1′″}_{r1′″} (in the formula, q1′″ is an integer of 1 to 3, q1′″ is preferably 2 or 3, and q1 is more preferably 3. Provided that the sum of q1″′ and r1′″ is 3).

The above R^{Si} is preferably —X¹—SiR^{b1}₂R^{c1} or —X¹—SiR^{b1}₃, and more preferably —X¹SiR^{b1}₃.

In one embodiment, when p1 is an integer of 1 to 3 in R^{Si}, R^{a1} is preferably —Z^{1′}—SiR^{b1′}₂R^{c1′} or —Z^{1′}—SiR^{b1′}₃, and more preferably —Z^{1′}—SiR^{b1′}₃. In the present embodiment, p1 is preferably 2 or 3, and more preferably 3.

In one embodiment, when p1′ is an integer of 1 to 3 in R^{Si}, R^{a1′} is preferably —Z^{1″}—SiR^{b1″}₂R^{c1″} or —Z^{1″}—SiR^{b1″}₃, and more preferably —Z^{1″}—SiR^{b1″}₃. In the present embodiment, p1′ is preferably 2 or 3, and more preferably 3.

In one embodiment, when p1″ is an integer of 1 to 3 in R^{Si}, R^{a1″} is preferably —Z^{1′″}—SiR^{b1″′}₂R^{c1″′} or —Z^{1′″}—SiR^{b1′″}₃, and more preferably —Z^{1′″}—SiR^{b1″′}₃. In the present embodiment, p1″ is preferably 2 or 3, and more preferably 3.

In one embodiment, the fluoropolyether group-containing compound of the present disclosure is a group represented by formula (1).

In one embodiment, the fluoropolyether group-containing compound of the present disclosure is a group represented by formula (2).

In one embodiment, the fluoropolyether group-containing compound of the present disclosure is represented by the following formula (1) or (2).

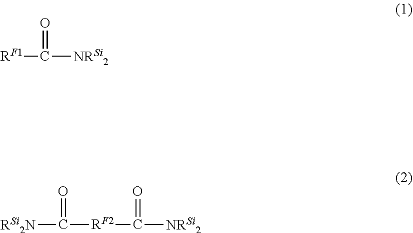

[In the formula:

R^{F1} is Rf¹—R^{F}—O_{q}—;

R^{F2} is —Rf²ₚ—R^{F}—O_{q}—;

Rf¹ is a C₁₋₁₆ alkyl group optionally substituted with one or more fluorine atoms;

Rf² is a C₁₋₆ alkylene group optionally substituted with one or more fluorine atoms;

R^{F} is each independently at each occurrence a group represented by formula: —(OC₄F₈)_{c}—(OC₃F₆)_{d}—(OC₂F₄)ₑ—(OCF₂)_{f}—, specifically, formula: —(OC₂F₄)ₑ—(OCF₂)_{f}— (in the formula, c and d are each independently an integer of 0 or more and 30 or less; e and f are each independently an integer of 1 or more and 200 or less, preferably 5 or more and 200 or less, and more preferably 10 or more and 200 or less; the occurrence order of the respective repeating units enclosed in parentheses provided with a subscript e or f is not limited in the formula; and the ratio of e to f is 0.9 or more, preferably 0.9 to 2.0, and more preferably 0.9 to 1.5);

p and q are each independently 0 or 1;

R^{Si} is each independently at each occurrence represented by the following formula (S1):

—X¹—SiR^{a1}ₚ₁R^{b1}_{q1}R^{c1}ᵣ₁ (S1);

X¹ is each independently at each occurrence a C₁₋₆ alkylene group or —(CH₂)_{z7}-phenylene-(CH₂)_{z8}—, preferably a C₁₋₆ alkylene group, and more preferably a C₁₋₃ alkylene group;

z7 is an integer of 0 to 6 and z8 is an integer of 1 to 6;

R^{b1} is each independently at each occurrence a hydroxyl group or a hydrolyzable group; and

p1 and r1 are 0, and q1 is 3.]

In one embodiment, the fluoropolyether group-containing compound of the present disclosure is represented by the following formula (1) or (2).

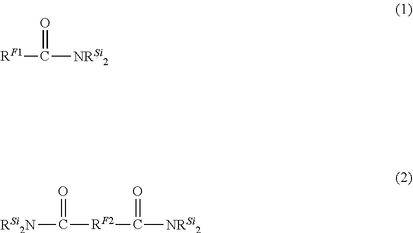

[In the formula:

R^{F1} is Rf¹—R^{F}—O_{q}—;

R^{F2} is —Rf²ₚ—R^{F}—O_{q}—;

the number average molecular weight of the group represented by R^{F1} or R^{F2} is in the range of 2,000 to 15,000, preferably in the range of 2,000 to 8,000, and more preferably in the range of 3,000 to 8,000;

Rf¹ is a C₁₋₁₆ alkyl group optionally substituted with one or more fluorine atoms;

Rf² is a C₁₋₆ alkylene group optionally substituted with one or more fluorine atoms;

R^{F} is each independently at each occurrence a group represented by formula: —(OC₄F₈)_{c}—(OC₃F₆)_{d}—(OC₂F₄)ₑ—(OCF₂)_{f}—, specifically, formula: —(OC₂F₄)ₑ—(OCF₂)_{f}— (in the formula, c and d are each independently an integer of 0 or more and 30 or less, e and f are each independently an integer of 1 or more and 200 or less, preferably 5 or more and 200 or less, and more preferably 10 or more and 200 or less, the occurrence order of the respective repeating units enclosed in parentheses provided with a subscript e or f is not limited in the formula, and the ratio of e to f is 0.9 or more, preferably 0.9 to 2.0, and more preferably 0.9 to 1.5);

p and q are each independently 0 or 1;

R^{Si} is each independently at each occurrence represented by the following formula (S1):

—X¹—SiR^{a1}ₚ₁R^{b1}_{q1}R^{c1}ᵣ₁ (S1);

X¹ is each independently at each occurrence a C₁₋₆ alkylene group or —(CH₂)_{z7}-phenylene-(CH₂)_{z8}—, preferably a C₁₋₆ alkylene group, and more preferably a C₁₋₃ alkylene group;

z7 is an integer of 0 to 6 and z8 is an integer of 1 to 6;

R^{b1} is each independently at each occurrence a hydroxyl group or a hydrolyzable group; and

p1 and r1 are 0, and q1 is 3.]

The compound represented by formula (1) or formula (2) can be produced by combining known methods.

As one embodiment, a method suited for producing the fluoropolyether group-containing compound of the present disclosure will be described below.

The fluoropolyether group-containing compound of the present disclosure can be produced by a method including: a step of allowing, for example, a compound represented by formula (1b) or (2b) and HSiM₃ (in the formula, M is each independently a halogen atom (that is, I, Br, Cl, or F) or a C₁₋₆ alkoxy group, preferably a halogen atom, and more preferably Cl) to react with each other, thereby affording a compound having —SiM₃ at the terminal (step (I)); and, if desired, a step of allowing it to react with a compound represented by R^{a1}L′ (R^{a1} has the same definition as described above, and L′ represents a group that can be bonded to R^{a1}) and/or a compound represented by R^{b1}L″ (R^{b1} has the same definition as described above, and L″ represents a group that can be bonded to R^{b1}) (step (II)).

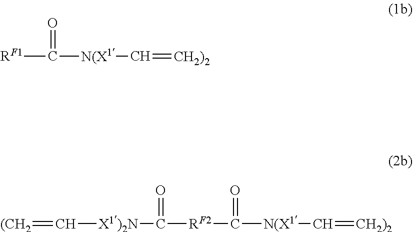

In formulas (1b) and (2b), R^{F1} and R^{F2} have the same definitions as R^{F1} and R^{F2} in the above formulas (1) and (2), respectively. X^{1′} represents a structure with two fewer carbon atoms than formulas (1) and (2). That is, —X^{1′}—CH₂CH₂— derived from the structure represented by —X^{1′}—CH═CH₂ corresponds to X¹ in formulas (1) and (2).

The above step is preferably carried out in an appropriate solvent in the presence of an appropriate catalyst.

The suitable catalyst is not limited, and examples thereof include Pt, Pd, and Rh. The catalyst may be in any form, for example, in the form of a complex.

The suitable solvent is not limited as long as it does not adversely affect the reaction, and examples thereof include 1,3-bis(trifluoromethyl)benzene, perfluorobutyl ethyl ether, perfluorohexyl methyl ether, perfluorohexane, and hexafluorobenzene.

The reaction temperature in the reaction is not limited, and it is usually 0 to 100° C. and preferably 50 to 80° C.; the reaction time is not limited, and it is usually 60 to 600 minutes and preferably 120 to 300 minutes; and the reaction pressure is not limited, and it is −0.2 to 1 MPa (gauge pressure) and is conveniently ambient pressure.

In another embodiment, the fluoropolyether group-containing compound of the present disclosure can be produced by a method including: a step of allowing the compound having —SiM₃ at the terminal, obtained in the above step (I), to react with Hal-J-CH═CH₂ (in the formula, J represents Mg, Cu, Pd, or Zn, and Hal represents a halogen atom), and if desired, a compound represented by R^{a1}L′ (R^{a1} has the same definition as described above, and L′ represents a group that can be bonded to R^{a1}) and/or a compound represented by R^{b1}L″ (R^{b1} has the same definition as described above, and L″ represents a group that can be bonded to R^{b1}) (step (II′)); and

a step of allowing the compound obtained in step (II′) to react with HSiM₃ (in the formula, M is each independently a halogen atom or a C₁₋₆ alkoxy group), and if desired,

a compound represented by formula: R^{b1′}_{i′}L′ (in the formula, R^{b1′} has the same definition as described above, L′ represents a group that can be bonded to R^{b1′}, and i′ is an integer of 1 to 3), and if desired,

a compound represented by formula: R^{c1′}_{j′}L″ (in the formula, R^{c1′} has the same definition as described above, L″ represents a group that can be bonded to R^{c1′}, and j′ is an integer of 1 to 3).

The above step is preferably conducted in an appropriate solvent in the presence of an appropriate catalyst.

The suitable catalyst is not limited, and examples thereof include Pt, Pd, and Rh. The catalyst may be in any form, for example, in the form of a complex.

The suitable solvent is not limited as long as it does not adversely affect the reaction and examples thereof include 1,3-bis(trifluoromethyl)benzene, perfluorobutyl ethyl ether, perfluorohexyl methyl ether, perfluorohexane, and hexafluorobenzene.

The reaction temperature in the reaction is not limited and it is usually 0 to 100° C. and preferably 50 to 80° C.; the reaction time is not limited and it is usually 60 to 600 minutes and preferably 120 to 300 minutes; and the reaction pressure is not limited, and it is −0.2 to 1 MPa (gauge pressure) and is conveniently ambient pressure.

The compounds represented by the above formulas (1b) and (2b) can be produced by, for example, introducing a group having a double bond into the terminal portion of the compound represented by formula (1a) or (2a). Specifically, it can be obtained by allowing the terminal R^{x} moiety of the compound represented by the following formula (1a) or (2a) and an amine compound (for example, diallylamine and the like) to react with each other.

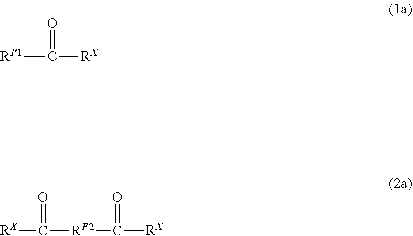

In formulas (1a) and (2a), R^{F1} and R^{F2} have the same definitions as R^{F1} and R^{F2} in formulas (1) and (2), respectively. R^{x} is, for example, a hydrogen atom, a hydroxyl group, an alkoxyl group having 1 to 10 carbon atoms, a phenol group, a sulfonyl group, halogen, or the like, and it is specifically a hydroxyl group.

The above step is preferably carried out in an appropriate solvent in the presence of an appropriate base.

The suitable base is not limited, and examples thereof include lithium hydroxide, sodium hydroxide, potassium hydroxide, sodium carbonate, potassium carbonate, sodium hydrogen carbonate, potassium hydrogen carbonate, and tertiary amines (triethylamine, pyridine, diisopropylethylamine, and 2,6-lutidine). The catalyst may be in any form, for example, in the form of a complex.

The suitable solvent is not limited as long as it does not adversely affect the reaction, and examples thereof include 1,3-bis(trifluoromethyl)benzene, perfluorobutyl ethyl ether, perfluorohexyl methyl ether, perfluorohexane and hexafluorobenzene.

The reaction temperature in the reaction is not limited, and it is usually 0 to 100° C. and preferably 40 to 80° C.; the reaction time is not limited, and it is usually 60 to 600 minutes and preferably 120 to 240 minutes; and the reaction pressure is not limited, and it is −0.2 to 1 MPa (gauge pressure) and is conveniently ambient pressure.

The reaction conditions upon producing the fluoropolyether group-containing silane compound of the present disclosure can be adjusted to a preferred range as appropriate by those skilled in the art.

Hereinafter, a composition of the present disclosure (for example, a surface-treating agent) will be described.

The composition of the present disclosure (for example, a surface-treating agent) contains at least one fluoropolyether group-containing compound represented by formula (1) or formula (2).

In one embodiment, the composition of the present disclosure (for example, a surface-treating agent) may contain the fluoropolyether group-containing compounds represented by formula (1) and formula (2). In the cured layer to be formed using the composition of the present embodiment, the water- and oil-repellency on its surface is particularly good. This is because, in the fluoropolyether group-containing compound contained in the composition of the present embodiment, the proportion of oxygen atoms contained in R^{F} is small (for example, smaller than the case where the e/f value is less than 0.9), that is, the proportion of fluorine atoms is large.

In one embodiment, the lower limit of the ratio (molar ratio) of the fluoropolyether group-containing compound represented by formula (2) to the fluoropolyether group-containing compounds represented by formula (1) and formula (2) in total in the composition of the present disclosure (for example, a surface-treating agent) may be preferably 0.001, more preferably 0.002, even more preferably 0.005, still more preferably 0.01, particularly preferably 0.02, and especially 0.05. The upper limit of the ratio (molar ratio) of the fluoropolyether group-containing compound represented by formula (2) to the fluoropolyether group-containing compounds represented by formula (1) and formula (2) in total may be preferably 0.35, more preferably 0.30, even more preferably 0.20, and still more preferably 0.15 or 0.10. The ratio (molar ratio) of the fluoropolyether group-containing compound represented by formula (2) to the fluoropolyether group-containing compounds represented by formula (1) and formula (2) in total is preferably 0.001 or more and 0.30 or less, more preferably 0.001 or more and 0.20 or less, even more preferably 0.002 or more and 0.20 or less, still more preferably 0.005 or more and 0.20 or less, and particularly preferably 0.01 or more and 0.20 or less, such as 0.02 or more and 0.20 or less (specifically, 0.15 or less) or 0.05 or more and 0.20 or less (specifically, 0.15 or less). By including the compounds in the above range, the composition of the present embodiment can contribute to formation of a cured layer having good friction durability.

In one embodiment, the lower limit of the ratio (molar ratio) of the fluoropolyether group-containing compound represented by formula (2) to the fluoropolyether group-containing compounds represented by formula (1) and formula (2) in total in the composition of the present disclosure (for example, a surface-treating agent) may be preferably 0.001, more preferably 0.002, even more preferably 0.005, still more preferably 0.01, particularly preferably 0.02 and especially 0.05. The upper limit of the ratio (molar ratio) of the fluoropolyether group-containing compound represented by formula (2) to the fluoropolyether group-containing compounds represented by formula (1) and formula (2) in total may be preferably 0.70, more preferably 0.60, more preferably 0.50, even more preferably 0.40, still more preferably 0.30 such as 0.20, and specifically 0.10. The ratio (molar ratio) of the fluoropolyether group-containing compound represented by formula (2) to the fluoropolyether group-containing compounds represented by formula (1) and formula (2) in total may be 0.001 or more and 0.70 or less, may be 0.001 or more and 0.60 or less, may be 0.001 or more and 0.50 or less, may be 0.002 or more and 0.40 or less, may be 0.005 or more and 0.30 or less, or may be 0.01 or more and 0.20 or less, and it is, for example, 0.02 or more and 0.20 or less (specifically, 0.15 or less) or 0.05 or more and 0.20 or less (specifically, 0.15 or less).

In one embodiment, the lower limit of the ratio (molar ratio) of the fluoropolyether group-containing compound represented by formula (1) to the fluoropolyether group-containing compounds represented by formula (1) and formula (2) in total in the composition of the present disclosure (for example, a surface-treating agent) may be preferably 0.001, more preferably 0.002, even more preferably 0.005, still more preferably 0.01, particularly preferably 0.02, and especially 0.05. The upper limit of the ratio (molar ratio) of the fluoropolyether group-containing compound represented by formula (1) to the fluoropolyether group-containing compounds represented by formula (1) and formula (2) in total may be preferably 0.70, more preferably 0.60, more preferably 0.50, even more preferably 0.40, still more preferably 0.30 such as 0.20, and specifically 0.10. The ratio (molar ratio) of the fluoropolyether group-containing compound represented by formula (1) to the fluoropolyether group-containing compounds represented by formula (1) and formula (2) in total may be 0.001 or more and 0.70 or less, may be 0.001 or more and 0.60 or less, may be 0.001 or more and 0.50 or less, may be 0.002 or more and 0.40 or less, may be 0.005 or more and 0.30 or less, or may be 0.01 or more and 0.20 or less, and it is, for example, 0.02 or more and 0.20 or less (specifically, 0.15 or less) or 0.05 or more and 0.20 or less (specifically, 0.15 or less).

The composition of the present disclosure (for example, a surface-treating agent) can impart water-repellency, oil-repellency, antifouling property, surface lubricity, and friction durability to a substrate, and may be suitably used as an antifouling coating agent or water-proof coating agent, although there are no limitations.

The composition of the present disclosure (for example, a surface-treating agent) may further contain a solvent, a (non-reactive) fluoropolyether compound that can be understood as a fluorine-containing oil, preferably a perfluoro(poly)ether compound (hereinafter, collectively referred to as a “fluorine-containing oil”), a (non-reactive) silicone compound that can be understood as a silicone oil (hereinafter, referred to as a “silicone oil”), a catalyst, a surfactant, a polymerization inhibitor, a sensitizer, and the like.

Examples of the above solvent include aliphatic hydrocarbons such as hexane, cyclohexane, heptane, octane, nonane, decane, undecane, dodecane, and mineral spirits; aromatic hydrocarbons such as benzene, toluene, xylene, naphthalene, and solvent naphtha; esters such as methyl acetate, ethyl acetate, propyl acetate, n-butyl acetate, isopropyl acetate, isobutyl acetate, cellosolve acetate, propylene glycol methyl ether acetate, carbitol acetate, diethyl oxalate, ethyl pyruvate, ethyl 2-hydroxybutyrate, ethyl acetoacetate, amyl acetate, methyl lactate, ethyl lactate, methyl 3-methoxypropionate, ethyl 3-methoxypropionate, methyl 2-hydroxyisobutyrate, and ethyl 2-hydroxyisobutyrate; ketones such as acetone, methyl ethyl ketone, methyl isobutyl ketone, 2-hexanone, cyclohexanone, methyl amino ketone, and 2-heptanone; glycol ethers such as ethyl cellosolve, methyl cellosolve, methyl cellosolve acetate, ethyl cellosolve acetate, propylene glycol monomethyl ether, propylene glycol monoethyl ether, propylene glycol monobutyl ether, propylene glycol monomethyl ether acetate, propylene glycol monoethyl ether acetate, propylene glycol monobutyl ether acetate, dipropylene glycol dimethyl ether, and ethylene glycol monoalkyl ether; alcohols such as methanol, ethanol, iso-propanol, n-butanol, isobutanol, tert-butanol, sec-butanol, 3-pentanol, octyl alcohol, 3-methyl-3-methoxybutanol, and tert-amyl alcohol; glycols such as ethylene glycol and propylene glycol; cyclic ethers such as tetrahydrofuran, tetrahydropyran, and dioxane; amides such as N,N-dimethylformamide and N,N-dimethylacetamide; ether alcohols such as methyl cellosolve, cellosolve, isopropyl cellosolve, butyl cellosolve, and diethylene glycol monomethyl ether; diethylene glycol monoethyl ether acetate; and fluorine-containing solvents such as 1,1,2-trichloro-1,2,2-trifluoroethane, 1,2-dichloro-1,1,2,2-tetrafluoroethane, dimethyl sulfoxide, 1,1-dichloro-1,2,2,3,3-pentafluoropropane (HCFC 225), Zeorora H, HFE 7100, HFE 7200, and HFE 7300. Alternatively, the solvent may be a mixed solvent of two or more of such solvents.

The fluorine-containing oil is not limited, and examples thereof include a compound (perfluoro(poly)ether compound) represented by the following general formula (3).

Rf⁵—(OC₄F₈)_{a′}—(OC₃F₆)_{b′}—(OC₂F₄)_{c′}—(OCF₂)_{d′}—Rf⁶ (3)

In the formula, Rf⁵ represents an alkyl group having 1 to 16 carbon atoms optionally substituted with one or more fluorine atoms (preferably, a C₁₋₁₆ perfluoroalkyl group), Rf⁶ represents an alkyl group having 1 to 16 carbon atoms optionally substituted with one or more fluorine atoms (preferably, a C₁₋₁₆ perfluoroalkyl group), a fluorine atom, or a hydrogen atom, and Rf⁵ and Rf⁶ are each independently, more preferably, a C₁₋₃ perfluoroalkyl group.

a′, b′, c′, and d′ respectively represent the numbers of 4 repeating units of perfluoro(poly)ether constituting the main backbone of the polymer and are mutually independently an integer of 0 or more and 300 or less, and the sum of a′, b′, c′, and d′ is at least 1, preferably 1 to 300, and more preferably 20 to 300. The occurrence order of the respective repeating units enclosed in parentheses provided with a subscript a′, b′, c′, or d′ is not limited in the formula. Among these repeating units, —(OC₄F₈)— may be any of —(OCF₂CF₂CF₂CF₂)—, —(OCF(CF₃)CF₂CF₂)—, (OCF₂CF(CF₃)CF₂)—, —(OCF₂CF₂CF(CF₃))—, —(OC(CF₃)₂CF₂)—, (OCF₂C(CF₃)₂)—, —(OCF(CF₃)CF(CF₃))—, —(OCF(C₂F₅)CF₂)—, and (OCF₂CF(C₂F₅))—, and it is preferably —(OCF₂CF₂CF₂CF₂)—. —(OC₃F₆)— may be any of —(OCF₂CF₂CF₂)— (OCF(CF₃)CF₂)—, and (OCF₂CF(CF₃))—, and it is preferably —(OCF₂CF₂CF₂)—. —(OC₂F₄)— may be any of —(OCF₂CF₂)— and (OCF(CF₃))—, and it is preferably —(OCF₂CF₂)—.

Examples of the perfluoro(poly)ether compound represented by the above general formula (3) include a compound represented by any of the following general formulas (3a) and (3b) (which may be used singly or as a mixture of two or more).

Rf⁵—(OCF₂CF₂CF₂)_{b″}—Rf⁶ (3a)

Rf⁵—(OCF₂CF₂CF₂CF₂)_{a″}—(OCF₂CF₂CF₂)_{b″}—(OCF₂CF₂)_{c″}—(OCF₂)_{d″}—Rf⁶ (3b)

In these formulas, Rf⁵ and Rf⁶ are as described above; in formula (3a), b″ is an integer of 1 or more and 100 or less; and in formula (3b), a″ and b″ are each independently an integer of 0 or more and 30 or less, and c″ and d″ are each independently an integer of 1 or more and 300 or less.

The occurrence order of the respective repeating units enclosed in parentheses provided with a subscript a″, b″, c″, or d″ is not limited in the formulas.

From another viewpoint, the fluorine-containing oil may be a compound represented by the general formula: Rf³—F (in the formula, Rf³ is a C₅₋₁₆ perfluoroalkyl group). The fluorine-containing oil may be a chlorotrifluoroethylene oligomer.

The above fluorine-containing oil may have an average molecular weight of 500 to 10,000. The molecular weight of the fluorine-containing oil may be measured using gel permeation chromatography (GPC).

The fluorine-containing oil may be contained in an amount of, for example, 0 to 50 mass %, preferably 0 to 30 mass %, and more preferably 0 to 5 mass % based on the composition of the present disclosure (for example, a surface-treating agent). In one embodiment, the composition of the present disclosure is substantially free of the fluorine-containing oil. Being substantially free of the fluorine-containing oil means that the fluorine-containing oil is not contained at all, or an extremely small amount of the fluorine-containing oil may be contained.

The fluorine-containing oil contributes to increasing the surface lubricity of a layer formed of the composition of the present disclosure (for example, a surface-treating agent).

For example, the above silicone oil may be a linear or cyclic silicone oil having 2,000 or less siloxane bonds.

The linear silicone oil may be so-called a straight silicone oil or modified silicone oil. Examples of the straight silicone oil include dimethyl silicone oil, methyl phenyl silicone oil, and methyl hydrogen silicone oil. Examples of the modified silicone oil include those obtained by modifying a straight silicone oil with alkyl, aralkyl, polyether, higher fatty acid ester, fluoroalkyl, amino, epoxy, carboxyl, alcohol, or the like. Examples of the cyclic silicone oil include cyclic dimethylsiloxane oil.

In the composition of the present disclosure (for example, a surface-treating agent), the silicone oil may be contained in an amount of, for example, 0 to 300 parts by mass, and preferably 50 to 200 parts by mass, based on total 100 parts by mass of the above fluoropolyether group-containing silane compound of the present disclosure (in the case of two or more kinds, the total thereof, and the same applies below).

The silicone oil contributes to increasing the surface lubricity of a layer formed of the composition of the present disclosure (for example, a surface-treating agent).

Examples of the above catalyst include an acid (for example, acetic acid, trifluoroacetic acid), a base (for example, ammonia, triethylamine, diethylamine) and a transition metal (for example, Ti, Ni, Sn).

The catalyst promotes hydrolysis and dehydrative condensation of the fluoropolyether group-containing silane compound of the present disclosure, and promotes formation of a layer formed of the composition of the present disclosure (for example, a surface-treating agent).

Examples of the other components include, in addition to those described above, tetraethoxysilane, methyltrimethoxysilane, 3-aminopropyltrimethoxysilane, 3-glycidoxypropyltrimethoxysilane, and methyltriacetoxysilane.

In one embodiment, for example, the compound represented by formula (2) may be contained at 70 mol % or less, may be contained at 60 mol % or less, or may be contained at 50 mol % or less, and may be contained at 0.001 mol % or more, may be contained at 0.01 mol % or more, or may be contained at 0.1 mol % or more, relative to the total of the compound represented by formula (1), the compound represented by formula (2), and the fluorine-containing oil. For example, the compound represented by formula (2) may be contained at 1 to 70 mol %, or may be contained at 5 to 50 mol %, relative to the total of the compound represented by formula (1), the compound represented by formula (2), and the fluorine-containing oil.

In one embodiment, the composition of the present disclosure (for example, a surface-treating agent) contains the compound represented by formula (1), the compound represented by formula (2), and the fluorine-containing oil.

In the present embodiment, for example, the fluorine-containing oil may be contained at 0.001 mol % or more, may be contained at 0.01 mol % or more, or may be contained at 1.0 mol % or more, and may be contained at 50 mol % or less, may be contained at 40 mol % or less, may be contained at 30 mol % or less, or may be contained at 10 mol % or less, relative to the total of the compound represented by formula (1), the compound represented by formula (2), and the fluorine-containing oil. For example, the fluorine-containing oil may be contained at 0.001 to 50 mol %, or may be contained at 0.01 to 40 mol %, relative to the total of the compound represented by formula (1), the compound represented by formula (2), and the fluorine-containing oil.

In the present embodiment, it is preferable that the compound represented by formula (2) be contained at 0.001 to 70 mol % and the fluorine-containing oil be contained at 0.001 to 50 mol %, it is more preferable that the compound represented by formula (2) be contained at 0.01 to 60 mol % and the fluorine-containing oil be contained at 0.01 to 40 mol %, and it is even more preferable that the compound represented by formula (2) be contained at 0.1 to 50 mol % and the fluorine-containing oil be contained at 0.1 to 30 mol %, relative to the total of the compound represented by formula (1), the compound represented by formula (2), and the fluorine-containing oil.

The composition of the present embodiment (for example, a surface-treating agent) can contribute to formation of a cured layer having good friction durability. Furthermore, in the cured layer to be formed using the composition of the present embodiment, the water- and oil-repellency on its surface is particularly good. This is because, in the fluoropolyether group-containing compound contained in the composition of the present embodiment, the proportion of oxygen atoms contained in R^{F} is small (for example, smaller than the case where the e/f value is less than 0.9), and the proportion of fluorine atoms is large.

In one embodiment, the composition of the present disclosure (for example, surface-treating agent) contains the compound represented by formula (1), the compound represented by formula (2), and the fluorine-containing oil.

In the present embodiment, the compound represented by formula (2) may be contained at 0.001 mol % or more and less than 50 mol %, may be contained at 0.1 mol % or more and less than 50 mol %, may be contained at 1 mol % or more and less than 50 mol %, or may be contained at, for example, 10 mol % or more and less than 50 mol %, relative to the total of the compound represented by formula (1) and compound represented by formula (2).

In one embodiment, the composition of the present disclosure (for example, a surface-treating agent) contains the compound represented by formula (1), the compound represented by formula (2) and the fluorine-containing oil.

In the present embodiment, the compound represented by formula (1) may be contained at 0.001 mol % or more and less than 50 mol %, may be contained at 0.1 mol % or more and less than 50 mol %, may be contained at 10 mol % or more and less than 50 mol %, or may be contained at, for example, 20 mol % or more and less than 50 mol % or 30 mol % or more and less than 50 mol %, relative to the total of the compound represented by formula (1) and the compound represented by formula (2).

In one embodiment, the composition of the present disclosure (for example, surface-treating agent) contains the compound represented by formula (1), the compound represented by formula (2) and the fluorine-containing oil.

In the present embodiment, the compound represented by formula (2) may be contained at 30 mol % or more and less than 65 mol %, may be contained at 35 mol % or more and less than 65 mol %, or may be contained at 40 mol % or more and less than 60 mol %, relative to the total of the compound represented by formula (1) and the compound represented by formula (2).

The composition of the present disclosure can be used as a surface-treating agent for surface treatment of a substrate.

The surface-treating agent of the present disclosure can be formed into a pellet by impregnating a porous material such as a porous ceramic material or that obtained by solidifying a metal fiber such as a steel wool, therewith.

The pellet can be used in, for example, vacuum deposition.

Hereinafter, an article of the present disclosure will be described.

The article of the present disclosure includes: a substrate; and a layer (surface-treating layer) on the surface of the substrate, where the layer is formed of the fluoropolyether group-containing silane compound of the present disclosure or a surface-treating agent containing the fluoropolyether group-containing silane compound (hereinafter, these are simply referred to as a “surface-treating agent of the present disclosure”, collectively).

The substrate that can be used in the present disclosure may be composed of any suitable material such as glass, a resin (which may be a natural or synthetic resin, for example, a common plastic material, and may be in the form of a plate, a film, or the like), a metal, ceramics, a semiconductor (such as silicon and germanium), a fiber (such as woven fabric and nonwoven fabric), fur, leather, a wood material, a ceramic material, a stone material, or a building material.

For example, when the article to be produced is an optical member, the material constituting the surface of the substrate may be a material for an optical member, such as glass or a transparent plastic. When the article to be produced is an optical member, some layer (or film) such as a hard coat layer or an antireflection layer may be formed on the surface (the outermost layer) of the substrate. The antireflection layer may be any of a single-layer antireflection layer and a multi-layer antireflection layer. Examples of inorganic substances that can be used in the antireflection layer include SiO₂, SiO, ZrO₂, TiO₂, TiO, Ti₂O₃, Ti₂O₅, Al₂O₃, Ta₂O₅, CeO₂, MgO, Y₂O₃, SnO₂, MgF₂, and WO₃. One of these inorganic substances may be used singly, or two or more may be used in combination (for example, as a mixture). In the case of a multi-layer antireflection layer, SiO₂ and/or SiO is preferably used in the outermost layer thereof. When the article to be produced is an optical glass component for a touch panel, a part of the surface of the substrate (glass) may have a transparent electrode such as a thin film in which indium tin oxide (ITO), indium zinc oxide, or the like is used. The substrate, according to its specific configuration or the like, may have an insulating layer, an adhesive layer, a protecting layer, a decorated frame layer (I-CON), an atomizing film layer, a hard coating layer, a polarizing film, a phase difference film, a liquid crystal display module, or the like.

The shape of the substrate is not limited. The surface region of the substrate on which a layer formed of the surface-treating agent of the present disclosure is to be formed is at least a part of the substrate surface, and may be suitably determined according to the application, specific specifications, and the like of an article to be produced.

The substrate, or at least the surface portion thereof, may be composed of a material originally having a hydroxyl group. Examples of the material include glass as well as metal (in particular, base metal) wherein a natural oxidized film or a thermal oxidized film is formed on the surface, ceramics, semiconductors, and the like. Alternatively, when the substrate has an insufficient amount of a hydroxyl group or when the substrate originally does not have a hydroxyl group as in resin and the like, a pre-treatment may be performed on the substrate to thereby introduce or increase a hydroxyl group on the surface of the substrate. Examples of the pre-treatment include a plasma treatment (for example, corona discharge) and ion beam irradiation. The plasma treatment can be suitably utilized to not only introduce or increase a hydroxyl group on the substrate surface, but also clean the substrate surface (remove foreign matter and the like). Another example of the pre-treatment includes a method wherein a monolayer of a surface adsorbent having a carbon-carbon unsaturated bonding group is formed on the surface of the substrate by a LB method (a Langmuir-Blodgett method), a chemical adsorption method, or the like beforehand, and thereafter cleaving the unsaturated bond under an atmosphere containing oxygen, nitrogen, or the like.

Alternatively, the substrate may be that of which at least the surface consists of a material comprising other reactive group such as a silicone compound having one or more Si—H group or alkoxysilane.

Then, on the surface of the substrate, a layer of the above surface-treating agent of the present disclosure is formed, this layer is post-treated as necessary, and thereby a layer is formed from the surface-treating agent of the present disclosure.

The layer of the surface-treating agent of the present disclosure can be formed by applying the above surface-treating agent on the surface of the substrate such that the surface-treating agent coats the surface. The coating method is not limited. For example, a wet coating method and a dry coating method can be used.

Examples of the wet coating method include dip coating, spin coating, flow coating, spray coating, roll coating, gravure coating, and similar methods.

Examples of the dry coating method include deposition (usually, vacuum deposition), sputtering, CVD, and similar methods. Specific examples of the deposition method (usually, a vacuum deposition method) include resistive heating, high-frequency heating using electron beam, microwave or the like, ion beam, and similar methods. Specific examples of the CVD method include plasma-CVD, optical CVD, thermal CVD, and similar methods.

Furthermore, coating by an atmospheric pressure plasma method can be performed.

When using the wet coating method, the surface-treating agent of the present disclosure can be applied to the substrate surface after being diluted with a solvent. From the viewpoint of the stability of the surface-treating agent of the present disclosure and the volatility of solvents, the following solvents are preferably used: perfluoroaliphatic hydrocarbons having 5 to 12 carbon atoms (such as perfluorohexane, perfluoromethylcyclohexane, and perfluoro-1,3-dimethylcyclohexane); polyfluoroaromatic hydrocarbons (such as bis(trifluoromethyl)benzene); polyfluoroaliphatic hydrocarbons (such as C₆F₁₃CH₂CH₃ (such as Asahiklin (registered trademark) AC-6000 manufactured by Asahi Glass Co., Ltd., and 1,1,2,2,3,3,4-heptafluorocyclopentane (such as Zeorora (registered trademark) H manufactured by Zeon Corporation)); alkyl perfluoroalkyl ethers (the perfluoroalkyl group and the alkyl group may be straight or branched) such as hydrofluoroether (HFE) (such as perfluoropropylmethyl ether (C₃F₇OCH₃) (such as Novec (trademark) 7000 manufactured by Sumitomo 3M Limited), perfluorobutyl methyl ether (C₄F₉OCH₃) (such as Novec (trademark) 7100 manufactured by Sumitomo 3M Limited), perfluorobutyl ethyl ether (C₄F₉OC₂H₅) (such as Novec (trademark) 7200 manufactured by Sumitomo 3M Limited), and perfluorohexyl methyl ether (C₂F₅CF(OCH₃) C₃F₇) (such as Novec (trademark) 7300 manufactured by Sumitomo 3M Limited), or CF₃CH₂OCF₂CHF₂ (such as Asahiklin (registered trademark) AE-3000 manufactured by Asahi Glass Co., Ltd.)). One of these solvents can be used singly, or two or more can be used as a mixture. In particular, hydrofluoroether is preferable, and perfluorobutyl methyl ether (C₄F₉OCH₃) and/or perfluorobutyl ethyl ether (C₄F₉OC₂H₅) is particularly preferable.

When using the dry coating method, the surface-treating agent of the present disclosure may be directly subjected to the dry coating method, or may be diluted with the above solvent before being subjected to the dry coating method.

A layer of the surface-treating agent is preferably formed such that the surface-treating agent of the present disclosure coexists in the layer with a catalyst for hydrolysis and dehydrative condensation. Conveniently, in the case of a wet coating method, the surface-treating agent of the present disclosure is diluted with a solvent, and then, immediately before application to the substrate surface, a catalyst may be added to the diluted solution of the surface-treating agent of the present disclosure. In the case of a dry coating method, the surface-treating agent of the present disclosure to which a catalyst has been added is directly used to a deposition (usually vacuum deposition) treatment, or a pellet-like material may be used to a deposition (usually vacuum deposition) treatment, wherein the pellet is obtained by impregnating a porous body of metal such as iron or copper with the surf ace-treating agent of the present disclosure to which the catalyst has been added.

The catalyst may be any suitable acid or base. The acid catalyst may be, for example, acetic acid, formic acid, or trifluoroacetic acid. The base catalyst may be, for example, ammonia or organic amine.

In the above-described manner, a layer derived from the surface-treating agent of the present disclosure is formed on the substrate surface, and the article of the present disclosure is produced. The layer thus obtained has both high surface lubricity and high friction durability. The above layer may have not only high friction durability but also have, depending on the compositional features of the surface-treating agent used, water-repellency, oil-repellency, antifouling property (for example, preventing fouling such as fingerprints from adhering), waterproof property (preventing water from penetrating into electronic components and the like), surface lubricity (or lubricity, such as removability by wiping for fouling including fingerprints and the like and excellent tactile sensations to the fingers), and the like, and may be suitably utilized as a functional thin film.

That is to say, the present disclosure further relates to an optical material having a layer derived from the surface-treating agent of the present disclosure in the outermost layer.

The optical material preferably includes a wide variety of optical materials in addition to optical materials relating to displays and the like as exemplified below: for example, displays such as cathode ray tubes (CRTs; for example, PC monitors), liquid crystal displays, plasma displays, organic EL displays, inorganic thin-film EL dot matrix displays, rear projection displays, vacuum fluorescent displays (VFDs), field emission displays (FEDs); protective plates for such displays; and those obtained by performing an antireflection film treatment on their surfaces.

The article having a layer obtained according to the present disclosure may be, but is not limited to, an optical member. Examples of the optical member include lenses of glasses or the like; front surface protective plates, antireflection plates, polarizing plates, and anti-glare plates for displays such as PDPs and LCDs; touch panel sheets for devices such as mobile phones and personal digital assistants; disc surfaces of optical discs such as Blu-ray (registered trademark) discs, DVD discs, CD-Rs, and MOs; optical fibers; and display surfaces of watches and clocks.

The article having a layer obtained according to the present disclosure may be an automobile interior or exterior member. Examples of the exterior material include the following: windows, light covers, and external camera covers. Examples of the interior material include the following: instrument panel covers, navigation system touch panels, and decorative interior materials.

The article having a layer obtained according to the present disclosure may be medical equipment or a medical material.

The thickness of the above layer is not limited. The thickness of the above layer in the case of an optical member is in the range of 1 to 50 nm, 1 to 30 nm, and preferably 1 to 15 nm, from the viewpoint of optical performance, surface lubricity, friction durability, and antifouling property.

Embodiments have been described above, but it will be understood that various modifications can be made to embodiments and details without departing from the spirit and the scope of the claims.

The present disclosure provides [1] to [19] below.

[1] A fluoropolyether group-containing compound of the following formula (1) or (2):

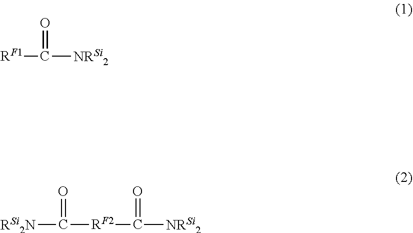

[In the formula:

R^{F1} is Rf¹—R^{F}—O_{q}—;

R^{F2} is —Rf²ₚ—R^{F}—O_{q}—;

Rf¹ is a C₁₋₁₆ alkyl group optionally substituted with one or more fluorine atoms;

Rf² is a C₁₋₆ alkylene group optionally substituted with one or more fluorine atoms;

R^{F} is each independently at each occurrence a group represented by the formula:

(OC₆F₁₂)ₐ—(OC₅F₁₀)_{b}—(OC₄F₈)_{c}—(OC₃R^{Fa}₆)_{d}—(OC₂F₄)ₑ—(OCF₂)_{f}—

a, b, c, and d are each independently an integer of 0 or more and 30 or less, e and f are each independently an integer of 1 or more and 200 or less, the sum of a, b, c, d, e, and f is at least 5 or more, the occurrence order of the respective repeating units enclosed in parentheses provided with a subscript a, b, c, d, e, or f is not limited in the formula, and a ratio of e to f is 0.9 or more;

R^{Fa} is each independently at each occurrence a hydrogen atom, a fluorine atom, or a chlorine atom;

p is 0 or 1;

q is independently 0 or 1;

R^{Si} is each independently at each occurrence represented by the following formula (S1):

—X¹—SiR^{a1}ₚ₁R^{b1}_{q1}R^{c1}ᵣ₁ (S1);

X¹ is each independently at each occurrence a single bond, an oxygen atom, or a divalent organic group;

R^{a1} is each independently at each occurrence —Z^{1′}—SiR^{a1′}_{p1′}R^{b1′}_{q1′}R^{c1′}_{r1′};

Z^{1′} is each independently at each occurrence a single bond, an oxygen atom, or a divalent organic group;

R^{a1′} is each independently at each occurrence —Z^{1″}—SiR^{a1″}_{p1″}R^{b1″}_{q1″}R^{c1″}_{r1″};

Z^{1″} is each independently at each occurrence a single bond, an oxygen atom, or a divalent organic group;

R^{a1″} is each independently at each occurrence —Z^{1′″}—SiR^{a1′″}_{p1′″}R^{b1′″}_{q1′″}R^{c1′″}_{r1′″};

Z^{1′″} is each independently at each occurrence a single bond, an oxygen atom, or a divalent organic group;

R^{b1′″} is each independently at each occurrence a hydroxyl group or a hydrolyzable group;

R^{c1′″} is each independently at each occurrence a hydrogen atom or a monovalent organic group;

q1′″ is each independently at each occurrence an integer of 0 to 3;

r1′″ is each independently at each occurrence an integer of 0 to 3;

R^{b1″} is each independently at each occurrence a hydroxyl group or a hydrolyzable group;

R^{c1″} is each independently at each occurrence a hydrogen atom or a monovalent organic group;

p1″ is each independently at each occurrence an integer of 0 to 3;

q1″ is each independently at each occurrence an integer of 0 to 3;

r1″ is each independently at each occurrence an integer of 0 to 3;

R^{b1′} is each independently at each occurrence a hydroxyl group or a hydrolyzable group;

R^{c1′} is each independently at each occurrence a hydrogen atom or a monovalent organic group;

p1′ is each independently at each occurrence an integer of 0 to 3;

q1′ is each independently at each occurrence an integer of 0 to 3;

r1′ is each independently at each occurrence an integer of 0 to 3;

R^{b1} is each independently at each occurrence a hydroxyl group or a hydrolyzable group;

R^{c1} is each independently at each occurrence a hydrogen atom or a monovalent organic group;

p1 is each independently at each occurrence an integer of 0 to 3;

q1 is each independently at each occurrence an integer of 0 to 3;

r1 is each independently at each occurrence an integer of 0 to 3, and

at least one R^{b1}, R^{b1′}, R^{b1″}, or R^{b1′″} is present in each group represented by R^{Si}.].

[2] The fluoropolyether group-containing compound according to [1], wherein R^{F} is represented by:

—(OC₄F₈)_{c}—(OC₃F₆)_{d}—(OC₂F₄)ₑ—(OCF₂)_{f}—

[In the formula:

c and d are each independently an integer of 0 or more and 30 or less, e and f are each independently an integer of 1 or more and 200 or less, and the occurrence order of the respective repeating units enclosed in parentheses provided with a subscript c, d, e, or f is not limited in the formula.].

[3] The fluoropolyether group-containing compound according to [1] or [2], wherein the ratio of e to f is in a range of 0.9 to 2.0.
[4] The fluoropolyether group-containing compound according to any one of [1] to [3], wherein X¹ is each independently at each occurrence a divalent organic group.
[5] The fluoropolyether group-containing compound according to any one of [1] to [4], wherein X¹ is each independently at each occurrence

—(Z²¹)_{z11}—(X²)_{z12}—(Z²²)_{z13}—

(In the formula, Z²¹ and Z²² are divalent organic groups;

X² is an oxygen atom;

z11 is 0 or 1;

z12 is 0 or 1;

z13 is 0 or 1, and

at least one of z11 and z13 is 1).

[6] The fluoropolyether group-containing compound according to any one of [1] to [5], wherein R^{Fa} is a fluorine atom.
[7] The fluoropolyether group-containing compound according to any one of [1] to [6], wherein p1 is 0 and q1 is 2 or 3.
[8] A surface-treating agent comprising the fluoropolyether group-containing compound according to any one of [1] to [7].
[9] The surface-treating agent according to [8], wherein the fluoropolyether group-containing compound comprises a compound represented by formula (1) and a compound represented by formula (2).
[10] The surface-treating agent according to [8] or [9], comprising the fluoropolyether group-containing compound of formula (2) at a molar ratio of 0.001 to 0.70 based on the fluoropolyether group-containing compounds of formula (1) and the fluoropolyether group-containing compound of (2) in total.
[11] The surface-treating agent according to any one of [8] to [10], further comprising one or more other components selected from a fluorine-containing oil, a silicone oil, and a catalyst.
[12] The surface-treating agent according to any one of [8] or [10], further comprising a fluorine-containing oil.
[13] The surface-treating agent according to [12], comprising 0.001 to 70 mol % of the compound of formula (2) and 0.001 to 50 mol % of the fluorine-containing oil based on the fluoropolyether group-containing compounds of formula (1), the fluoropolyether group-containing compound of (2), and the fluorine-containing oil in total.
[14] The surface-treating agent according to any one of [8] to [13], further comprising a solvent.
[15] The surface-treating agent according to any one of [8] to [14], which is used as an antifouling coating agent or a water-proof coating agent.
[16] The surface-treating agent according to any one of [8] to [15], which is for vacuum deposition.
[17] A pellet comprising the surface-treating agent according to any one of [8] to [15].
[18] An article comprising: a substrate; and a layer on a surface of the substrate, wherein the layer is formed of the compound according to any one of [1] to [7] or the surface-treating agent according to any one of [8] to [16].
[19] The article according to [18], which is an optical member.

### EXAMPLES

The present disclosure will be described more specifically through the following Examples, but it is not limited to these Examples. In the Examples, all chemical formulas shown below indicate average compositional features, and the occurrence order of repeating units (such as (OCF₂CF₂) and (OCF₂)) constituting perfluoropolyether is arbitrary.

### Synthetic Example 1

5.0 g of a mixture of CF₃—(OCF₂CF₂)ₘ—(OCF₂)ₙ—COOH (m≈27 and n≈25) and HOCOCF₂—(OCF₂CF₂)ₘ—(OCF₂)ₙ—COOH (m≈27 and n≈25) (provided that the content of HOCOCF₂—(OCF₂CF₂)ₘ—(OCF₂)ₙ—COOH was 8 mol %) was dissolved in 5.0 g of 1,3-bis(trifluoromethyl)benzene and cooled with ice. After adding 0.3 g of thionyl chloride dropwise to that solution, 0.01 mg of N,N-dimethylformamide was further added thereto, and the mixture was stirred at room temperature for 24 hours. Thionyl chloride was distilled off from this reaction solution, then 0.18 g of diallylamine and 0.2 g of triethylamine were added thereto, and the mixture was heated to 50° C. and stirred for 3 hours. The end point of the reaction was confirmed by ¹⁹F-NMR according to that the chemical shift of the carbonyl group α position —CF₂— of CF₃—(OCF₂CF₂)ₘ—(OCF₂)ₙ—COOH shifted to a low magnetic field, and by ¹H-NMR according to that the methylene proton at the amino group α position of diallylamine shifted to a low magnetic field. 1N-hydrochloric acid was added to the reaction solution, and the separated lower phase was washed with water, dried using magnesium sulfate, and concentrated. The obtained concentrated product was dissolved in perfluorohexane and washed with acetone three times, thereby affording a mixture containing a polyether group-containing compound (A) and a polyether group-containing compound (A′).

Polyether group-containing compound (A):

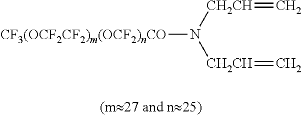

Polyether group-containing compound (A′):

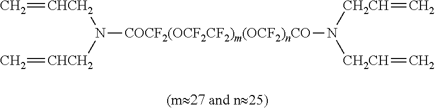

### Synthetic Example 2

5.0 g of the mixture obtained in Synthetic Example 1 was dissolved in 10 ml of 1,3-bis(trifluoromethyl)benzene, 0.02 g of triacetoxymethylsilane and 0.06 ml of a xylene solution containing 2% Pt complex of 1,3-divinyl-1,1,3,3-tetramethyldisiloxane were added thereto, then 1.0 g of trichlorosilane was introduced, and the mixture was stirred at 10° C. for 30 minutes. Subsequently, that solution was heated to 60° C. and stirred for 4 hours. Thereafter, from the obtained solution, volatiles were distilled off under reduced pressure, then a mixed solution of 0.1 g of methanol and 3.0 g of trimethyl orthoformate was added thereto, and the mixture was heated to 60° C. and stirred for 3 hours. Thereafter, purification was performed, and thus 4.7 g of a mixture containing the following polyether group-containing compound (B) and polyether group-containing compound (B′) having trimethoxysilyl groups at terminals was obtained (the e/f ratio was 1.08).

Polyether group-containing compound (B):

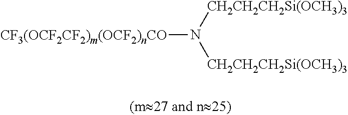

Polyether group-containing compound (B′):

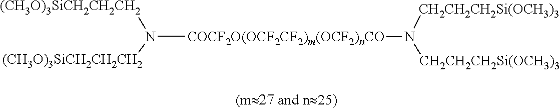

### Synthetic Example 3

The same operations as in Synthetic Example 1 were carried out except that 6.0 g of a mixture containing CF₃—(OCF₂CF₂)ₘ—(OCF₂)ₙ—COOH (m≈33 and n≈32) and HOCOCF₂—(OCF₂CF₂)ₘ—(OCF₂)ₙ—COOH (m≈33 and n≈32) (provided that the content of HOCOCF₂—(OCF₂CF₂)ₘ—(OCF₂)ₙ—COOH was 11 mol %) was used, and thus 6.0 g of a mixture containing a polyether group-containing compound (C) and a polyether group-containing compound (C′) was obtained.

Polyether group-containing compound (C):

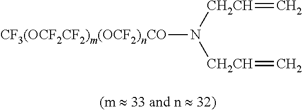

Polyether group-containing compound (C′):

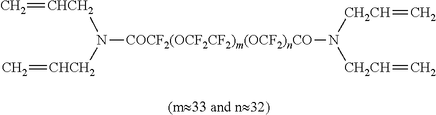

### Synthetic Example 4

The same operations as in Synthetic Example 2 were carried out except that 5.8 g of the mixture obtained in Synthetic Example 3 was used, and thus 5.8 g of a mixture containing a polyether group-containing compound (D) and a polyether group-containing compound (D′) was obtained (the e/f ratio was 1.03).

Polyether group-containing compound (D):

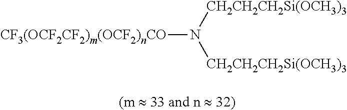

Polyether group-containing compound (D′):

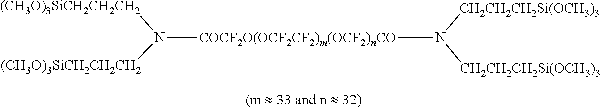

### Synthetic Example 5

The same operations as in Synthetic Example 1 were carried out except that 6.0 g of a mixture containing CF₃—(OCF₂CF₂)ₘ—(OCF₂)ₙ—COOH (m≈27 and n≈25), HOCOCF₂—(OCF₂CF₂)ₘ—(OCF₂)ₙ—COOH (m≈27 and n≈25), and CF₃—(OCF₂CF₂)ₘ—(OCF₂)ₙ—OCF₃ (m≈27 and n≈25) (provided that the content of HOCOCF₂—(OCF₂CF₂)ₘ—(OCF₂)ₙ—COOH was 29 mol % and the content of CF₃—(OCF₂CF₂)ₘ—(OCF₂)ₙ—OCF₃ was 24 mol %) was used, and thus 5.9 g of a mixture containing a polyether group-containing compound (E), a polyether group-containing compound (E′), and a polyether group-containing compound (E″) was obtained.

Polyether group-containing compound (E):

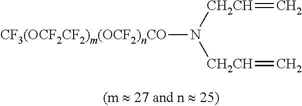

Polyether group-containing compound (E′):

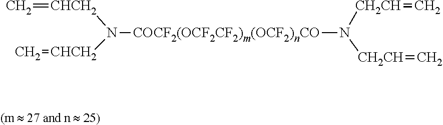

Polyether group-containing compound (E″):

CF₃(OCF₂CF₂)ₘ(OCF₂)ₙOCF₃ (m≈27 and n≈25)

### Synthetic Example 6

The same operations as in Synthetic Example 2 were carried out except that 5.9 g of the mixture obtained in Synthetic Example 5 was used, and thus 5.8 g of a mixture containing a polyether group-containing compound (F), a polyether group-containing compound (F′), and a polyether group-containing compound (F″) was obtained (the e/f ratio was 1.08).

Polyether group-containing compound (F):

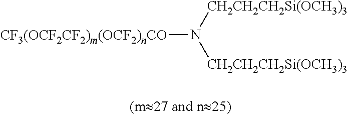

Polyether group-containing compound (F′):

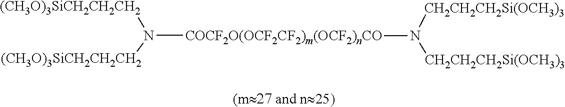

Polyether group-containing compound (F″):

CF₃(OCF₂CF₂)ₘ(OCF₂)ₙOCF₃ (m≈27 and n≈25)

### Example 1

The mixture containing the polyether group-containing compound (B) and the polyether group-containing compound (B′) obtained in the above Synthetic Example 2 was dissolved in hydrofluoroether (Novec HFE-7200, manufactured by 3M) so as to have a concentration of 0.1 mass %, and thus a surface-treating agent (1) was prepared.

### Example 2

The mixture containing the polyether group-containing compound (D) and the polyether group-containing compound (D′) obtained in the above Synthetic Example 4 was dissolved in hydrofluoroether (Novec HFE-7200, manufactured by 3M) so as to have a concentration of 0.1 mass %, and thus a surface-treating agent (2) was prepared.

### Example 3

The mixture containing the polyether group-containing compound (F), the polyether group-containing compound (F′), and the polyether group-containing compound (F″) obtained in the above Synthetic Example 6 was dissolved in hydrofluoroether (Novec HFE-7200, manufactured by 3M) so as to have a concentration of 0.1 mass %, and thus a surface-treating agent (3) was prepared.

### Comparative Examples 1 and 2

Comparative surface-treating agents (1) and (2) were respectively prepared in the same manner as in Example 2 except that the following control compounds (1) and (2) were used in place of the mixture containing the polyether group-containing compound (D) and the polyether group-containing compound (D′).

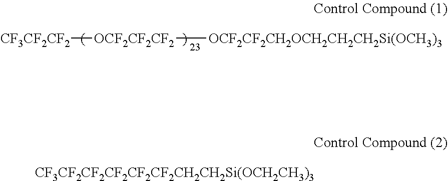

### (Static Contact Angle)

The static contact angle was measured by the following method using a fully automatic contact angle meter DropMaster 700 (manufactured by Kyowa Interface Science Co., Ltd.).

### <Method for Measuring Static Contact Angle>

The static contact angle was determined by dripping 2 μL of water from a microsyringe onto a horizontally placed substrate and taking a still image with a video microscope 1 second after the dripping.

### (Formation of Cured Film)

The surface-treating agents (1) to (3) and the comparative surface-treating agents (1) to (2) were used to form cured films as follows.

A surface-treating agent or a comparative surface-treating agent was applied to a chemically tempered glass (“Gorilla” glass, manufactured by Corning Incorporated, thickness 0.7 mm) using a spin coater.

The spin coating conditions were 300 rpm for 3 seconds and 2000 rpm for 30 seconds.

The coated glass was heated at 150° C. for 30 minutes in a thermostatic oven in air to form a cured film.

### [Evaluation of Cured Film Characteristics]

Characteristics of the obtained cured film were evaluated as follows.

### <Static Contact Angle>

### (Initial Evaluation)

First, as an initial evaluation, after the cured film was formed, the static water contact angle of the surface with which nothing was brought into contact yet was measured.

(Evaluation after Wiping with Ethanol)

The cured film was wiped back and forth five times with Kimwipe (trade name, manufactured by Jujo Kimberly Co., Ltd.) sufficiently soaked with ethanol, and dried. After drying, the static water contact angle of the cured film was measured.

### <Fingerprint Adherability and Removability by Wiping>

### (Fingerprint Adherability)

A finger was pressed against a cured film formed using a surface-treating agent or a comparative surface-treating agent, and how easily a fingerprint adheres was visually judged. Evaluations were made according to the following criteria:

A: Fingerprint unlikely adhered, or not noticeable even when adhered.

B: Adhered fingerprint was little, but fingerprint sufficiently confirmed.

C: Fingerprint adhered as clearly as fingerprint on untreated glass substrate.

### (Fingerprint Removability by Wiping)

After the above fingerprint adherability test, the adhered fingerprint was wiped off back and forth five times with Kimwipe (trade name, manufactured by Jujo Kimberly Co., Ltd.), and how easily the adhered fingerprint was wiped off was visually judged. Evaluations were made according to the following criteria:

A: Fingerprint completely wiped off.

B: Fingerprint wiping marks remained.

C: Fingerprint wiping marks spread, and difficult to remove.

The results of the series of evaluations are summarized in Table 1 below.

TABLE 1

| | | | | Fingerprint adherability and | |
|---|---|---|---|---|---|
| | | | | removability by wiping | |
| | | Contact angle (degree) | | | Fingerprint |
| | | Initial | After wiping | Fingerprint | removability |
| Treatment agent | | evaluation | with ethanol | adherability | by wiping |
| Surface-treating | Example 1 | 115 | 115 | A | A |
| agent (1) | | | | | |
| Surface-treating | Example 2 | 114 | 114 | A | A |
| agent (2) | | | | | |
| Surface-treating | Example 3 | 115 | 115 | A | A |
| agent (3) | | | | | |
| Comparative | Comparative | 113 | 112 | A | B |
| surface-treating | Example 1 | | | | |
| agent (1) | | | | | |
| Comparative | Comparative | 105 | 103 | B | C |
| surface-treating | Example 2 | | | | |
| agent (2) | | | | | |

The contact angles of the cured films formed using the surface-treating agents (1) to (3) had good initial evaluation values, and furthermore, they were not decreased even when the films were wiped using ethanol. On the other hand, the contact angles of the cured films formed using the comparative surface-treating agents (1) and (2) were decreased when the films were wiped using ethanol. This is considered to be because the cured films formed with the comparative surface-treating agents (1) and (2) have poor chemical resistance (durability against solvents).

### [Evaluation of Cured Film Frictional Resistance]

The frictional resistance of the obtained cured film was evaluated as follows.

### <Frictional Resistance Test Against Eraser>

Using a rubbing tester (manufactured by Shinto Scientific Co., Ltd.), the water resistance contact angle was measured every 2,500 rubs under the following conditions, and the test was continued until it reached 10,000 rubs or until the angle became less than 100 degrees. The test environment conditions were 25° C. and a humidity of 40% RH.

Eraser: Raber Eraser (manufactured by Minoan)

Contact area: 6 mmφ

Moving distance (one way): 30 mm

Moving speed: 3,600 mm/min

Load: 1 kg/6 mmφ

The results of the above evaluation are summarized in Table 2 below. In the table, means that the measurement was not performed.

TABLE 2

| | | Eraser friction count | | | | |
|---|---|---|---|---|---|---|
| | | 0 | 2,500 | 5,000 | 7,500 | 10,000 |
| Treatment agent | | times | times | times | times | times |
| Surface-treating | Example 1 | 115 | 114 | 116 | 112 | 108 |
| agent (1) | | | | | | |
| Surface-treating | Example 2 | 114 | 114 | 115 | 114 | 111 |
| agent (2) | | | | | | |
| Surface-treating | Example 3 | 115 | 115 | 115 | 113 | 110 |
| agent (3) | | | | | | |
| Comparative | Comparative | 113 | 89 | — | — | — |
| surface-treating | Example 1 | | | | | |
| agent (1) | | | | | | |

### INDUSTRIAL APPLICABILITY

The fluoropolyether group-containing compound of the present disclosure can be suitably utilized to form a surface-treating layer on the surface of a variety of substrates, in particular optical members for which friction durability is required.

What is claimed is:

1. A fluoropolyether group-containing compound of the following formula (1): 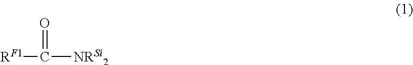
wherein:
R^{F1} is Rf¹—R^{F}—O_{q}—;
Rf¹ is a methyl group optionally substituted with one or more fluorine atoms;
R^{F} is each independently at each occurrence a group represented by the formula:
—(OC₆F₁₂)ₐ—(OC₅F₁₀)_{b}—(OC₄F₈)_{c}—(OC₃R^{Fa}₆)_{d}—(OC₂F₄)ₑ—(OCF₂)_{f}—;
a, b, c, and d are each independently an integer of 0 or more and 30 or less, e and f are each independently an integer of 1 or more and 200 or less; the sum of a, b, c, d, e, and f is at least 5 or more; the occurrence order of the respective repeating units enclosed in parentheses provided with a subscript a, b, c, d, e, or f is not limited in the formula; and a ratio of e to f is 0.9 or more;
R^{Fa} is each independently at each occurrence a hydrogen atom, a fluorine atom, or a chlorine atom;
q is independently 0 or 1;
R^{Si} is each independently at each occurrence represented by the following formula (S1):
—X¹—SiR^{a1}ₚ₁R^{b1}_{q1}R^{c1}ᵣ₁ (S1);
X¹ is each independently at each occurrence a single bond, an oxygen atom, or a divalent organic group;
R^{a1} is each independently at each occurrence —Z^{1′}—SiR^{a1′}_{p1′}R^{b1′}_{q1′}R^{c1′}_{r1′};
Z^{1′} is each independently at each occurrence a single bond, an oxygen atom, or a divalent organic group;
R^{a1′} is each independently at each occurrence —Z^{1″}—SiR^{a1″}_{p1″}R^{b1″}_{q1″}R^{c1″}_{r1″};
Z^{1″} is each independently at each occurrence a single bond, an oxygen atom, or a divalent organic group;
R^{a1″} is each independently at each occurrence —Z^{1′″}—SiR^{a1′″}_{p1′″}R^{b1′″}_{q1′″}R^{c1′″}_{r1′″};
Z^{1′″} is each independently at each occurrence a single bond, an oxygen atom, or a divalent organic group;
R^{b1′″} is each independently at each occurrence a hydroxyl group or a hydrolyzable group;
R^{c1′″} is each independently at each occurrence a hydrogen atom or a monovalent organic group;
q1′″ is each independently at each occurrence an integer of 0 to 3;
r1′″ is each independently at each occurrence an integer of 0 to 3;
R^{b1″} is each independently at each occurrence a hydroxyl group or a hydrolyzable group;
R^{c1″} is each independently at each occurrence a hydrogen atom or a monovalent organic group;
p1″ is each independently at each occurrence an integer of 0 to 3;
q1″ is each independently at each occurrence an integer of 0 to 3;
r1″ is each independently at each occurrence an integer of 0 to 3;
R^{b1′} is each independently at each occurrence a hydroxyl group or a hydrolyzable group;
R^{c1′} is each independently at each occurrence a hydrogen atom or a monovalent organic group;
p1′ is each independently at each occurrence an integer of 0 to 3;
q1′ is each independently at each occurrence an integer of 0 to 3;
r1′ is each independently at each occurrence an integer of 0 to 3;
R^{b1} is each independently at each occurrence a hydroxyl group or a hydrolyzable group;
R^{c1} is each independently at each occurrence a hydrogen atom or a monovalent organic group;
p1 is each independently at each occurrence an integer of 0 to 3;
q1 is each independently at each occurrence an integer of 0 to 3;
r1 is each independently at each occurrence an integer of 0 to 3, and
at least one R^{b1}, R^{b1′}, R^{b1″}, or R^{b1′″} is present in each group represented by R^{Si}.

2. The fluoropolyether group-containing compound according to claim 1, wherein R^{F} is represented by:
—(OC₄F₈)_{c}—(OC₃F₆)_{d}—(OC₂F₄)ₑ—(OCF₂)_{f}—
wherein:
c and d are each independently an integer of 0 or more and 30 or less; e and f are each independently an integer of 1 or more and 200 or less; and the occurrence order of the respective repeating units enclosed in parentheses provided with a subscript c, d, e, or f is not limited in the formula.

3. The fluoropolyether group-containing compound according to claim 1, wherein the ratio of e to f is in a range of 0.9 to 2.0.

4. The fluoropolyether group-containing compound according to claim 1, wherein X¹ is each independently at each occurrence a divalent organic group.

5. The fluoropolyether group-containing compound according to claim 1, wherein X¹ is each independently at each occurrence
—(Z²¹)_{z11}—(X²)_{z12}—(Z²²)_{z13}—
wherein: Z²¹ and Z²² are divalent organic groups;
X² is an oxygen atom;
z11 is 0 or 1;
z12 is 0 or 1;
z13 is 0 or 1, and
at least one of z11 and z13 is 1.

6. The fluoropolyether group-containing compound according to claim 1, wherein R^{Fa} is a fluorine atom.

7. The fluoropolyether group-containing compound according to claim 1, wherein p1 is 0 and q1 is 2 or 3.
